(19) United States
(12) Patent Application Publication
(10) Pub. No.: US 2023/0156583 A1
(43) Pub. Date: May 18, 2023

(54) RAN SLICING

(71) Applicant: IPLA HOLDINGS INC., New York, NY (US)

(72) Inventors: Joseph MURRAY, Wilmington, DE (US); Pascal ADJAKPLE, Wilmington, DE (US); Michael STARSINIC, Wilmington, DE (US); Jiwan NINGLEKHU, Wilmington, DE (US); Patrick SVEDMAN, Wilmington, DE (US); Kyle PAN, Wilmington, DE (US); Mohamed AWADIN, Wilmington, DE (US); Zhuo CHEN, Wilmington, DE (US); Yifan LI, Wilmington, DE (US); Allan TSAI, Wilmington, DE (US)

(73) Assignee: IPLA HOLDINGS INC., New York, NY (US)

(21) Appl. No.: 17/910,373

(22) PCT Filed: Mar. 12, 2021
(86) PCT No.: PCT/US2021/022086

§ 371 Date: Sep. 9, 2022

Related U.S. Application Data
(60) Provisional application No. 62/989,082, filed on Mar. 13, 2020.

(51) Int. Cl. H04W 48/18; H04W 48/20; H04W 60/04; H04W 76/20

(52) U.S. Cl. CPC H04W 48/18; H04W 48/20; H04W 60/04; H04W 76/20

(57) ABSTRACT

Methods, systems, or devices may assist in performing slice-based cell selection and reselection, offloading of initial access attempts for a given slice to a specific frequency layer, performing slice-aware PLMN selection, performing slice-based barring, performing slice-based Random Access, or performing slice-based paging, among other things.

### CROSS-REFERENCE TO RELATED APPLICATIONS

This application claims the benefit of U.S. Provisional Patent Application No. 62/989,082, filed on Mar. 13, 2020, entitled “RAN Slicing,” the contents of which are hereby incorporated by reference herein.

### BACKGROUND

Mobility in RRC_IDLE/RRC_INACTIVE—Cell Selection

The principles of PLMN selection in NR are based on the 3GPP PLMN selection principles. Cell selection is required on transition from RM-DEREGISTERED to RM-REGISTERED, from CM-IDLE to CM-CONNECTED and from CM-CONNECTED to CM-IDLE and is based on the following principles:
The UE NAS layer identifies a selected PLMN and equivalent PLMNs;
Cell selection is always based on Cell Defining SSBs (CD-SSBs) located on the synchronization raster:
   The UE searches the NR frequency bands and for each carrier frequency identifies the strongest cell as per the CD-SSB. It then reads cell system information broadcast to identify its PLMN(s):
      The UE may search each carrier in turn (“initial cell selection”) or make use of stored information to shorten the search (“stored information cell selection”).
The UE seeks to identify a suitable cell; if it is not able to identify a suitable cell it seeks to identify an acceptable cell. When a suitable cell is found or if only an acceptable cell is found it camps on that cell and commences the cell reselection procedure:
   A suitable cell is one for which the measured cell attributes satisfy the cell selection criteria; the cell PLMN is the selected PLMN, registered or an equivalent PLMN; the cell is not barred or reserved and the cell is not part of a tracking area which is in the list of “forbidden tracking areas for roaming”;
   An acceptable cell is one for which the measured cell attributes satisfy the cell selection criteria and the cell is not barred.

Transition to RRC_IDLE:

On transition from RRC_CONNECTED or RRC_INACTIVE to RRC_IDLE, a UE should camp on a cell as result of cell selection according to the frequency assigned by RRC in the state transition message if any.

Recovery from Out of Coverage:

The UE should attempt to find a suitable cell in the manner described for stored information or initial cell selection herein. If no suitable cell is found on any frequency or RAT, the UE should attempt to find an acceptable cell.

In multi-beam operations, the cell quality is derived amongst the beams corresponding to the same cell.

Cell Reselection

A UE in RRC_IDLE/RRC_INACTIVE performs cell reselection. The principles of the procedure are the following:
Cell reselection is always based on CD-SSBs located on the synchronization raster.
The UE makes measurements of attributes of the serving and neighbour cells to enable the reselection process:
   For the search and measurement of inter-frequency neighboring cells, only the carrier frequencies need to be indicated.
Cell reselection identifies the cell that the UE should camp on. It is based on cell reselection criteria which involves measurements of the serving and neighbour cells:
   Intra-frequency reselection is based on ranking of cells;
   Inter-frequency reselection is based on absolute priorities where a UE tries to camp on the highest priority frequency available;
   A Neighbor Cell List (NCL) can be provided by the serving cell to handle specific cases for intra- and inter-frequency neighboring cells;
   Black lists can be provided to prevent the UE from reselecting to specific intra- and inter-frequency neighboring cells;
   Cell reselection can be speed dependent;
   Service specific prioritization.

In multi-beam operations, the cell quality is derived amongst the beams corresponding to the same cell.

The cell-ranking criterion Rs for serving cell and Rn for neighboring cells is defined by:

Rs=Qmeas,s+Qhyst−Qoffsettemp

Rn=Qmeas,n−Qoffset−Qoffsettemp

where:
Qmeas RSRP measurement quantity used in cell reselections.
Qoffset For intra-frequency: Equals to Qoffset_{s,n}, if Qoffset_{s,n} is valid, otherwise this equals to zero.
   For inter-frequency: Equals to Qoffset_{s,n} plus Qoffset_{frequency}, if Qoffset_{s,n} is valid, otherwise this equals to Qoffset_{frequency}.
Qoffsettemp Offset temporarily applied to a cell as specified in TS 38.331 [1].

The UE may also consider the number of beams above a threshold when performing cell reselection.

Cell Categories

The cells are categorized according to which services they offer, such as acceptable cell, suitable cell, barred cell, or reserved cell.

Acceptable cell: An “acceptable cell” is a cell on which the UE may camp to obtain limited service (originate emergency calls and receive ETWS and CMAS notifications). Such a cell shall fulfil the following requirements, which is the minimum set of requirements to initiate an emergency call and to receive ETWS and CMAS notification in an NR network:
The cell is not barred, see clause 5.3.1 of TS 38.304 [2] (3GPP TS 38.304, User Equipment (UE) procedures in Idle mode and RRC Inactive state (Release 15), V15.6.0);
The cell selection criteria are fulfilled, see clause 5.2.3.2 of TS 38.304 [2].

Suitable cell: A cell is considered as suitable if the following conditions are fulfilled:
The cell is part of the selected PLMN or the registered PLMN or PLMN of the Equivalent PLMN list;
The cell selection criteria are fulfilled, see clause 5.2.3.2 of TS 38.304 [2].

According to the latest information provided by NAS: 1) The cell is not barred, see clause 5.3.1 of TS 38.304 [2]; 2) The cell is part of at least one TA that is not part of the list of “Forbidden Tracking Areas” (TS 22.261 [3]-3GPP TS 22.261, Service requirements for the 5G system; Stage 1, V16.10.0), which belongs to a PLMN that fulfils the first bullet herein (e.g., cell is part of the selected PLMN or the registered PLMN or PLMN of the Equivalent PLMN list)

Barred cell: A cell is barred if it is so indicated in the system information, as specified in TS 38.331 [1].

Reserved cell: A cell is reserved if it is so indicated in system information, as specified in TS 38.331 [1]. Following exception to these definitions are applicable for UEs:
if a UE has an ongoing emergency call, all acceptable cells of that PLMN are treated as suitable for the duration of the emergency call.
camped on a cell that belongs to a registration area that is forbidden for regional provision of service; a cell that belongs to a registration area that is forbidden for regional provision service (TS 23.122 [4], TS 24.501 [5]) is suitable but provides only limited service.

Mobility in RRC_IDLE/RRC_INACTIVE—Unified Access Control

TS 24.501 [5] (3GPP TS 24.501, Non-Access-Stratum (NAS) protocol for 5G System (5GS); Stage 3, V16.3.0) defines access control techniques for the 5G System.

When the 5G NAS layer of a UE detects that it has MO data or signaling to send, the NAS layer needs to perform the mapping of the kind of data or signaling to one or more access identities and one access category and lower layers will perform access barring checks for that request based on the determined access identities and access category. The allowable Access Identity and Access Category Values are defined in TS 22.261 [3].

Access Categories are numbered 0-63. Numbers 32-63 are reserved for operator use. Operators may use NAS singling to configure definitions for each of these categories in the UE. The definitions may be based on what Data Network Name (DNN) the access is associated with, what Single-Network Slice Selection Assistance Information (S-NSSAI) the access is associated with, etc.

The NG-RAN may broadcast barring control information associated with Access Categories and Access Identities as specified in TS 38.300 [6] (3GPP TS 38.300, NR; NR and NG-RAN Overall Description; Stage 2 (Release 15), V15.8.0).

This background information is provided to reveal information believed by the applicant to be of possible relevance. No admission is necessarily intended, nor should be construed, that any of the preceding information constitutes prior art.

### SUMMARY

Disclosed herein are methods, systems, or devices that may assist in performing slice-based cell selection and reselection, offloading of initial access attempts for a given slice to a specific frequency layer, performing slice-aware PLMN selection, performing slice-based barring, performing slice-based Random Access, or performing slice-based paging, among other things.

Methods, systems, or devices may perform slice-based cell selection and reselection, where the UE considers the available slices in a cell when deciding which cell to (re-) select. In an example, a mechanism for providing the AS with an NSSAI, that is used to inform the UE of the slice(s) that will be accessed, or are likely to be accessed, when establishing/resuming and RRC connection. In an example, mechanisms to allow a UE to quickly and efficiently determine the slice(s) available in a cell.

There are methods for categorizing cells based on the slices available in the cell. There are methods to perform cell selection using slice-based cell selection criteria. There are mechanisms for determining slice-based reselection priorities handling. There are mechanisms to limit cell reselection measurements that is based on which S-NSSAIs are available in the Serving Cell. There are method for excluding a cell for reselection based on S-NSSAI availability. There are methods to determine the reselection priority of a given frequency that is a function of the S-NSSAI availability. There are methods to determine slice-based cell ranking criteria for the serving cell and neighboring cells. There are methods for triggering cell reselection evaluation based on the S-NSSAI based cell selection criteria. There are methods to control the slice-based cell selection and reselection behavior of the UE, which may be used by the network to “steer” the UE towards cells that support specific S-NSSAIs or to “offload” the UE to specific cells or frequency layers when transitioning the UE to RRC_IDLE or RRC_INACTIVE.

Methods, systems, or devices may be used to define a Slice Registration Area, that is used to inform a UE of the availability of a network slice within a subset of cells in the PLMN, and methods for the network to determine when the UE moves in/out of an area where a given slice is available.

Methods, systems, or devices may perform a slice-aware RRC Connection Establishment/Resume procedure, where a UE that is camped on a cell that does not support the desired slice(s), reselects a cell that does support the desired slice(s) before commencing with the RACH procedure to establish/resume the RRC connection.

Methods, systems, or devices may allow offloading of initial access attempts for a given slice to a specific frequency layer, where the cell reselection priority of a given frequency may be determined, at least in part, on the slice for which the RRC connection is being established/resumed.

Methods, systems, or devices may perform slice-aware PLMN selection, where information that can be used to determine the slice availability for one or more PLMNs at the UEs current location may be reported to the NAS.

There may be a mechanism to control when the UE may search for additional cells on a carrier that is based on the slices supported by the strongest cell(s).

Methods, systems, or devices may perform slice-based barring. There are mechanisms to indicate to a UE that a slice is barred. There are mechanisms for handling registration requests for barred slices, where the RAN node informs the AMF of S-NSSAIs that should be rejected. There are mapping rules to determine an access category for an access attempt pertaining to a specific slice.

Methods, systems, or devices may improve the efficiency of the existing unified access control mechanism, where the operator-defined access category definitions Information Element that is sent to the UE during registration, or during a configuration update, is updated to include a unique identifier that identifies the set of definitions that are carried in the IE.

Methods, systems, or devices may perform slice-based Random Access. There are methods to perform service-based partitioning of RACH resources. There are methods to perform slice-based prioritized Random Access

Methods, systems, or devices may perform slice-based Paging. There are slice-based paging mechanisms wherein, the UE behavior in terms of paging monitoring, UE addressing for paging message notification or paging message content is specific to slice or group of slices the UE is interested in.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates RRC_IDLE and RRC_INACTIVE Cell Selection and Reselection;

FIG. 2 illustrates Network Control of Slice-Based Cell (Re-)Selection Behavior via the RRCRelease Message;

FIG. 3 illustrates Slice Availability in UE's Registration Area;

FIG. 4 illustrates Slice Area Registration Update via Registration Request Procedure;

FIG. 5 illustrates Slice Area Registration Update via RNA Update Procedure;

FIG. 6 illustrates Slice-Aware RRC Connection Establishment Procedure (MO Access);

FIG. 7 illustrates Slice-Aware RRC Connection Establishment Procedure (MT Access);

FIG. 8 illustrates Procedure for Offloading Initial Access Attempts for a Given Slice to a Specific Frequency Layer;

FIG. 9 illustrates UE Learning that a Slice is Barred and the UE takes Action;

FIG. 10 illustrates an exemplary RAN Slicing procedure;

FIG. 11 illustrates an exemplary RAN slicing procedure;

FIG. 12 illustrates an exemplary RAN slicing procedure;

FIG. 13 illustrates an exemplary display (e.g., graphical user interface) that may be generated based on the methods, systems, and devices of RAN slicing;

FIG. 14A illustrates an example communications system;

FIG. 14B illustrates an exemplary system that includes RANs and core networks;

FIG. 14C illustrates an exemplary system that includes RANs and core networks;

FIG. 14D illustrates an exemplary system that includes RANs and core networks;

FIG. 14E illustrates another example communications system;

FIG. 14F illustrates a block diagram of an example apparatus or device; and

FIG. 14G illustrates a block diagram of an exemplary computing system.

### DETAILED DESCRIPTION

### Network Slicing

TS 38.300 [6] defines the general principles and requirements related to the realization of network slicing in the NG-RAN for NR connected to 5GC and for E-UTRA connected to 5GC are given.

A network slice includes a CN part, and one or more of a RAN part, a non-3GPP Access Network part, or a wireline access network part. For example, the RAN part may comprise of one or more RAN capabilities (for example SDAP capability parameters, PDCP capability parameters, RLC capability parameters, MAC capability parameters or Physical layer capability parameters for e.g. supported frequency ranges or frequency bands, frequency band combinations), one or more RAN characteristics (for example supported service type such as eMBB (Slice suitable for the handling of 5G enhanced Mobile Broadband), URLLC (Slice suitable for the handling of ultra-reliable low latency communications), MioT (Slice suitable for the handling of massive IoT), V2X (Slice suitable for the handling of V2X services)), REDCAP (Slice suitable for the handling of Reduced Capability UEs)), one or more RAN functions (e.g., control plane function, or user plane function), and the required resources (e.g., compute, storage and networking resources). Similarly, the CN part may comprise for example of one or more CN capabilities (for e.g. AMF capability parameters, SMF capability parameters or UPF capability parameters), one or more CN characteristics (for example supported service type such as eMBB (Slice suitable for the handling of 5G enhanced Mobile Broadband), URLLC (Slice suitable for the handling of ultra-reliable low latency communications), MioT (Slice suitable for the handling of massive IoT), V2X (Slice suitable for the handling of V2X services)), REDCAP (Slice suitable for the handling of Reduced Capability UEs)), one or more CN functions (e.g., control plane function, or user plane function), and the required resources (e.g., compute, storage and networking resources). The non-3GPP Access Network part or the wireline access network part may comprise of one or more Access Network capabilities (for example MAC capability parameters or Physical layer capability parameters for e.g. supported frequency ranges or frequency bands, frequency band combinations, supported bandwidth or bandwidth combination as applicable), one or more Access Network characteristics (for example supported service type such as eMBB (Slice suitable for the handling of 5G enhanced Mobile Broadband), URLLC (Slice suitable for the handling of ultra-reliable low latency communications), MioT (Slice suitable for the handling of massive IoT), V2X (Slice suitable for the handling of V2X services)), REDCAP (Slice suitable for the handling of Reduced Capability UEs)), one or more Access Network functions (e.g., control plane function, or user plane function), and the required resources (e.g., compute, storage and networking resources). The support of network slicing relies on the principle that traffic for different slices is handled by different PDU sessions. Network can realize the different network slices by scheduling and also by providing different L1/L2 configurations.

Each network slice is uniquely identified by a S-NSSAI [7] (3GPP TS 23.501, System Architecture for the 5G System; Stage 2 (Release 16), V16.3.0). Network Slice Selection Assistance Information (NSSAI) includes one or a list of S-NSSAIs where a S-NSSAI is a combination of: mandatory SST (Slice/Service Type) field, which identifies the slice type and includes 8 bits (with range is 0-255); and SD (Slice Differentiator) field, which differentiates among Slices with same SST field and may include 24 bits.

The list includes at most 8 S-NSSAI(s).

The UE provides NSSAI (Network Slice Selection Assistance Information) for network slice selection in RRCSetupComplete, if it has been provided by NAS. While the network can support large number of slices (hundreds), the UE need not support more than 8 slices simultaneously.

Network Slicing is a concept to allow differentiated treatment depending on each customer requirements. With slicing, it is possible for Mobile Network Operators (MNO) to consider customers as belonging to different tenant types with each having different service requirements that govern in terms of what slice types each tenant is eligible to use based on Service Level Agreement (SLA) and subscriptions.

The following principles, disclosed in more detail, may be considered for support of Network Slicing in NG-RAN: 1) RAN awareness of slices; 2) Selection of RAN part of the network slice; 3) Resource management between slices; 4) Support of QoS; 5) RAN selection of CN entity; 6) Resource isolation between slices; 7) Access control; 8) Slice availability; 9) Support for UE associating with multiple network slices simultaneously; 10) Granularity of slice awareness; or 11) Validation of UE rights to access a network slice.

RAN awareness of slices: NG-RAN supports a differentiated handling of traffic for different network slices which have been pre-configured. How NG-RAN supports the slice enabling in terms of NG-RAN functions (e.g., the set of network functions that comprise each slice) is implementation dependent.

Selection of RAN part of the network slice: NG-RAN supports the selection of the RAN part of the network slice, based on the Requested NSSAI provided by the UE or the 5GC which unambiguously identifies one or more of the pre-configured network slices in the PLMN.

Resource management between slices: NG-RAN supports policy enforcement between slices as per service level agreements. It should be possible for a single NG-RAN node to support multiple slices. The NG-RAN should be free to apply the best RRM policy for the SLA in place to each supported slice.

Support of QoS: NG-RAN supports QoS differentiation within a slice.

RAN selection of CN entity: During initial Registration procedure, the UE may provide NSSAI to support the selection of an AMF. If available, NG-RAN uses this information for routing the initial NAS to an AMF. If the NG-RAN is unable to select an AMF using this information or the UE does not provide any such information the NG-RAN sends the NAS signaling to one of the default AMFs.

For subsequent accesses, the UE provides a Temp ID, which is assigned to the UE by the 5GC, to enable the NG-RAN to route the NAS message to the appropriate AMF as long as the Temp ID is valid (NG-RAN is aware of and can reach the AMF which is associated with the Temp ID). Otherwise, the methods for initial attach applies.

Resource isolation between slices: The NG-RAN supports resource isolation between slices. NG-RAN resource isolation may be achieved by means of RRM policies and protection mechanisms that should avoid the shortage of shared resources if one slice breaks the service level agreement for another slice. It should be possible to fully dedicate NG-RAN resources to a certain slice. How NG-RAN supports resource isolation is implementation dependent.

Access control: By means of the unified access control, operator-defined access categories can be used to enable differentiated handling for different slices. NG-RAN may broadcast barring control information (e.g., a list of barring parameters associated with operator-defined access categories) to minimize the impact of congested slices.

Slice Availability: Some slices may be available only in part of the network. The NG-RAN supported S-NSSAI(s) is configured by OAM. Awareness in the NG-RAN of the slices supported in the cells of its neighbors may be beneficial for inter-frequency mobility in connected mode. It is assumed that the slice availability does not change within the UE's registration area.

The NG-RAN and the 5GC are responsible to handle a service request for a slice that may or may not be available in a given area. Admission or rejection of access to a slice may depend by factors such as support for the slice, availability of resources, support of the requested service by NG-RAN.

Support for UE associating with multiple network slices simultaneously: In case a UE is associated with multiple slices simultaneously, only one signaling connection is maintained and for intra-frequency cell reselection, the UE always tries to camp on the best cell. For inter-frequency cell reselection, dedicated priorities can be used to control the frequency on which the UE camps.

Granularity of slice awareness: Slice awareness in NG-RAN is introduced at PDU session level, by indicating the S-NSSAI corresponding to the PDU Session, in signaling including PDU session resource information.

Validation of the UE rights to access a network slice: It is the responsibility of the 5GC to validate that the UE has the rights to access a network slice. Prior to receiving the Initial Context Setup Request message, the NG-RAN may be allowed to apply some provisional/local policies, based on awareness of which slice the UE is requesting access to. During the initial context setup, the NG-RAN is informed of the slice for which resources are being requested.

Scenario #1: How to (Re-)Select a Cell that Supports the Intended Slice(s)

As part of the R17 study on enhancement of RAN slicing, RAN2 has agreed to “Study mechanisms to enable UE fast access to the cell supporting the intended slice.” This includes the study of slice-based cell reselection under network control. Existing mechanisms used to control cell (re-)selection were not designed considering cells may support different slices. This can result in a UE camping on a cell that does not support the intended slice(s). When this happens, the network may have to perform a handover or reject and redirect the UE to a cell that supports the intended slice, which will result in additional signaling and access delays. Mechanisms used to prioritize frequencies can be leveraged to “steer” a UE to cells that support specific slices, but this can be too restrictive since it requires cells in a UE's registration area on a given frequency to support the same slices. Therefore, to enable fast access to the cell supporting the intended slice, there is a need for a mechanism that allows a UE to consider what slice(s) a cell supports when performing cell (re-)selection, and the 5G system needs to be enhanced to allow the UE to determine that slices are supported by a cell.

Furthermore, a UE can be registered to up to 8 slices simultaneously, e.g. can be configured with up to 8 allowed S-NSSAIs. 3GPP is considering relaxing the requirement that the slice availability does not change within the UE's registration area; therefore, it may be possible that some of the cells in a UEs registration area do not support the slices that are in the UE's Allowed NSSAI. This can result in the UE camping on a cell that does not support slices that the UE needs to access, even if slice-based cell reselection is used. Therefore, for scenarios where a UE camps on a cell that does not support all of the slices in the UE's Allowed NSSAI, the 5G system should be enhanced to support the following scenarios. First, the UE may be camped on a cell and should generate MO traffic that is associated with a slice that is not supported in the cell. Second, the network may need to send MT traffic to the UE, but the UE may be camped on a cell that does not support the slice associated with the MT traffic.

Scenario #2: Initial Access Imbalance on Different Frequency Layers for Deployments where Slices are Coupled with Carrier/Frequency

Operators may couple carrier/frequency with slices, e.g. eMBB slices are supported on 2.6 GHz and 4.9 GHz, while URLLC slices are only supported on 4.9 GHz. To enable fast access to the cells supporting the intended slice(s), the network may be configured to “steer” a UE to camp on a specific frequency layer depending the service required, e.g. a UE requiring eMBB service would be “steered” towards 2.6 GHz cells, and a UE requiring URLLC service would be “steered” towards 4.9 GHz cells. A UE requiring support for multiple services would be “steered” towards a frequency layer supporting the required slices, e.g. a UE requiring eMBB and URLLC services will be “steered” towards 4.9 GHz cells. This is advantageous for scenarios where the UE attempts to resume/establish a URLLC connection, since the UE will camp on a cell that supports URLLC. But for scenarios where an eMBB traffic is being resumed or established, this can result in overloading the 4.9 GHz cells with access attempts or traffic that may be targeted to the 2.6 GHz cells. Therefore, for scenarios where slices are coupled with carrier or frequency, there is a need for a mechanism to balance access attempts across the frequency layers that support the slice(s) for which the access attempt is being made.

Scenario #3: Selection of a PLMN that does not Support the Intended Slice(s) at the UEs Location

When the UE performs PLMN selection, the PLMN identities of the strongest cell found on each frequency are reported to the NAS. The slices supported by the measured cell are not reported to the NAS, therefore the PLMN selection is not based on the slices supported by the measured cells. This is not problematic for scenarios where all the cells in the network support the same slices. However, for some use cases, it may be useful to only deploy a slice in part of the PLMN. For such deployments, the existing procedure may result in selecting a PLMN that does not support all of the slices in the UE's Configured NSSAI or the slices that the UE intends to include in the Requested NSSAI of the UEs next Registration Request at the UEs current location. Therefore, there is a need for a slice-aware PLMN selection procedure that considers the slices supported by the measured cells.

### Scenario #4: Overloading Common Resources Used for Network Access

Cells supporting multiple slices may use common resources for network access procedures such as random access and paging. This can result in blocking or delaying access to a given slice due to access attempts made for another slice. To ensure SLAs are met, operators may overprovision their networks with resources used for network access, which is very inefficient. Therefore, there is a need for a mechanism that ensures signaling for access procedures for one slice do not block or delay the execution of access procedures for another slice.

Disclosed herein with reference to scenario 1 and other scenarios are methods to perform slice-based cell selection and reselection, where the UE considers the available slices in a cell when deciding which cell to (re-)select. For example, a mechanism for providing the AS with an NSSAI, that is used to inform the UE of the slice(s) that will be accessed, or are likely to be accessed, when establishing/resuming and RRC connection. Mechanisms may allow a UE to quickly and efficiently determine the slice(s) available in a cell. Methods may allow for categorizing cells based on the slices available in the cell. There are methods to perform cell selection using slice-based cell selection criteria. There is a mechanism for determining slice-based reselection priorities handling. There is a mechanism to limit cell reselection measurements that is based on which S-NSSAIs are available in the Serving Cell. There is a method for excluding a cell for reselection based on S-NSSAI availability. Methods can determine the reselection priority of a given frequency that is a function of the S-NSSAI availability. There is a method to determine slice-based cell ranking criteria for the serving cell and neighboring cells. There may be methods for triggering cell reselection evaluation based on the S-NSSAI based cell selection criteria. There are methods to control the slice-based cell selection and reselection behavior of the UE, which may be used by the network to “steer” the UE towards cells that support specific S-NSSAIs or to “offload” the UE to specific cells or frequency layers when transitioning the UE to RRC_IDLE or RRC_INACTIVE.

Further disclosed with regard to scenario #1, and other scenarios, is a definition of a Slice Registration Area, that is used to inform a UE of the availability of a network slice within a subset of cells in the PLMN, and methods for the network to determine when the UE moves in/out of an area where a given slice is available.

Further disclosed with regard to scenario #1, and other scenarios is a method to perform a slice-aware RRC Connection Establishment/Resume procedure, where a UE that is camped on a cell that does not support the desired slice(s), reselects a cell that does support the desired slice(s) before commencing with the RACH procedure to establish/resume the RRC connection.

Disclosed with regard to scenario #2, and other scenarios is a method to allow offloading of initial access attempts for a given slice to a specific frequency layer, where the cell reselection priority of a given frequency may be determined, at least in part, on the slice for which the RRC connection is being established/resumed.

Disclosed with regard to scenario #3, and other scenarios, are methods to perform slice-aware PLMN selection, where information that can be used to determine the slice availability for one or more PLMNs at the UEs current location may be reported to the NAS. Further disclosed are mechanisms to control when the UE may search for additional cells on a carrier that is based on the slices supported by the strongest cell(s).

Further disclosed herein with regard to scenario #4 and other scenarios are methods to perform slice-based barring, such as: 1) a mechanism to indicate to a UE that a slice is barred; 2) a mechanism for handling registration requests for barred slices, where the RAN node informs the AMF of S-NSSAIs that should be rejected; or 3) mapping rules to determine an access category for an access attempt pertaining to a specific slice.

With continued reference to scenario #4, and other scenarios, disclosed herein are methods for improving the efficiency of the existing unified access control mechanism, where the operator-defined access category definitions information element (IE) that is sent to the UE during registration, or during a configuration update, is updated to include a unique identifier that identifies the set of definitions that are carried in the IE. Disclosed herein are methods to perform slice-based Random Access, such as a method to perform service-based partitioning of RACH resources; or methods to perform slice-based prioritized random access.

Further, with regard to scenario #4, and other scenarios are methods to perform slice-based Paging, such as a slice-based paging mechanism wherein, the UE behavior in terms of paging monitoring, UE addressing for paging message notification or paging message content is specific to slice or group of slices the UE is interested in.

Although some methods are particularly advantageous to implement with regard to a scenario, it is contemplated herein that the methods, steps, or mechanisms, among other things may be used across methods to address one or more scenarios, which may not be specifically provided herein.

Mechanisms Associated with Scenario #1

Network Slicing allows an operator to provide differentiated treatment depending on each customer's requirements. MNOs can consider customers as belonging to different tenant types, where service requirements of the tenant govern what network slice types a tenant is eligible to use; this is typically based on SLAs and subscription configuration. A network slice, e.g. an S-NSSAI, may be deployed throughout an entire PLMN or in specific cells within a PLMN. For example, an operator may deploy a network slice in a limited geographic area, e.g. hospital, business park, factory etc., to provide differentiated service for UEs in a specific area. When deployed in specific cells, network slice availability may be defined on a cell, RAN-Based Notification Area (RNA), Tracking Area (TA), or Registration Area (RA) basis. Network slices may also be deployed on specific frequency layers. For example, to co-exist with existing LTE systems, the NR TDD configuration should be aligned with LTE. Therefore, bands where LTE is already deployed, e.g. 2.6 GHz., are more suitable for network slices supporting voice and eMBB services, while bands where LTE is not deployed, e.g. 4.9 GHz, are more suitable for network slices supporting URLLC services with low latency.

NAS or AS signaling may be used to inform a UE of the availability of a network slice within a PLMN, e.g. the frequency (or frequencies), cells, RNAs, TAs, or RAs that support a given network slice. For example, Slice Specific Mobility Restrictions provided by the AMF in the NAS Registration and Configuration Update procedures may be used to inform the UE of the availability of a slice in a geographical region or frequency layer. After being informed of the availability of a network slice within a PLMN, the UE may determine whether or not a given cell supports the network slice based on the cell's Physical Cell ID (PCI); corresponding RNA, TA, or RA; or the frequency layer on which the cell is operating. Awareness of which network slices are available in a given cell may then be used enable slice-based cell selection and reselection in accordance with the subject matter described herein.

A cell may also indicate which slices it supports via SI broadcast. For example, the SI broadcast by a cell may include an IE comprised of a list of network slices, e.g. S-NSSAIs, supported by the cell. This IE may be included in an existing SIB or a new SIB may be defined to include the list of network slices supported by the cell. To minimize signaling overhead, the SIB(s) that includes the list of network slices supported by the cell may be configured such that it is only broadcast in response to an on-demand SI request for the corresponding SI message to which the SIB(s) that include the list of network slices supported by the cell are mapped. SI broadcast of slice availability for a given cell may be used on its own or in combination with other the methods described herein to inform a UE of the availability of a network slice within a PLMN. It should be appreciated that instead of broadcasting S-NSSAI values, the SI broadcast might only include partial S-NSSAI values, for example, SST or SD values that are supported in the cell. Alternately, the cell may broadcast S-NSSAI's, SST's, or SD's that are not supported in the cell.

And in other alternatives, RACH-based mechanisms may be used, where Msg1, Msg2 or MsgA is used to request information about the slices supported by the cell, and Msg2, Msg4 or MsgB is used to provide the UE with the information about the slices supported by the cell.

### Slice-Based Cell Selection and Reselection

With cell selection, the UE searches for a suitable cell of the selected PLMN, chooses that cell to provide available services, and monitors its control channel. This procedure is defined as “camping on the cell”. With slice-based cell selection, the UE also considers the available slices in a cell, and slice-related information, when deciding which cell to choose to provide available services.

The UE shall, if necessary, then register its presence, by means of a NAS registration procedure, in the tracking area of the chosen cell. As an outcome of a successful Location Registration, the selected PLMN then becomes the registered PLMN, as specified in TS 23.122.

If the UE finds a more suitable cell, according to the cell reselection criteria, it reselects onto that cell and camps on it. In the case of slice-based cell reselection, the UE also considers the available slices in a cell, and slice-related information, when ranking the cells according the cell reselection criteria. If the new cell does not belong to at least one tracking area to which the UE is registered, location registration is performed. In RRC_INACTIVE state, if the new cell does not belong to the configured RNA, an RNA update procedure is performed.

Reasons for camping on a cell in RRC_IDLE state and RRC_INACTIVE state may be fourfold: First, it enables the UE to receive system information from the PLMN. Second, when registered and if the UE wishes to establish an RRC connection or resume a suspended RRC connection, it can do this by initially accessing the network on the control channel of the cell on which it is camped. Slice-based cell (re-)selection ensures the UE camps on a cell supporting the slice(s) it is likely to use when establishing or resuming an RRC connection. Third, if the network needs to send a message or deliver data to the registered UE, it knows (in most cases) the set of tracking areas (in RRC_IDLE state) or RNA (in RRC_INACTIVE state) in which the UE is camped. It can then send a “paging” message for the UE on the control channels of the cells in the corresponding set of areas. The UE will then receive the paging message and can respond. Slice-based cell (re-)selection ensures the UE camps on a cell supporting the slice(s) it is likely to use when responding to a page. Fourth, it enables the UE to receive Earth and Tsunami Warning System (ETWS) and Commercial Mobile Alert System (CMAS) notifications.

Table 1 presents the functional division between UE NAS and UE AS in RRC_IDLE and RRC_INACTIVE states.

TABLE 1
Functional Division between NAS and AS in
RRC_IDLE State and RRC_INACTIVE State

| Procedure | UE NAS | UE AS |
|---|---|---|
| Cell Selection | Control cell selection for | Perform measurements |
| | example by indicating | needed to support cell |
| | RAT(s) associated with the | selection. |
| | selected PLMN to be used | Detect and synchronise to a |
| | initially in the search of a | broadcast channel. Receive |
| | cell in the cell selection. | and handle broadcast |
| | Maintain a list of “Forbidden | information. Forward NAS |
| | Tracking Areas” and provide | system information to NAS. |
| | the list to AS. | Search for a suitable cell. The |
| | | cells broadcast one or more |
| | | ‘PLMN identity’ in the system |
| | | information. Respond to NAS |
| | | whether such cell is found or |
| | | not. |
| | | If associated RATs is (are) set |
| | | for the PLMN, perform the |
| | | search in this (these) RAT(s) |
| | | and other RATs for that |
| | | PLMN as specified in TS |
| | | 23.122. |
| | | If a cell is found which |
| | | satisfies cell selection |
| | | criteria, camp on that cell. |
| Cell Reselection | Maintain a list of equivalent | Perform measurements |
| | PLMN identities and provide | needed to support cell |
| | the list to AS. | reselection. |
| | Maintain a list of “Forbidden | Detect and synchronise to a |
| | Tracking Areas” and provide | broadcast channel. Receive |
| | the list to AS. | and handle broadcast |
| | Maintain a CRS-NSSAI and | information. Forward NAS |
| | provide it to the AS. | system information to NAS. |
| | | Change cell if a more suitable |
| | | cell is found. |

### CRS-NSSAI

To enable slice-based cell (re-)selection, upper layers, e.g. NAS, may provide the AS with an NSSAI, e.g. the Cell (Re-)Selection NSSAI (CRS-NSSAI). The 5-NSSAI(s) in the CRS-NSSAI may correspond to the Requested NSSAI, the Allowed NSSAI or a combination of one or more S-NSSAIs from the Configured NSSAI, or default Configured NSSAI, for the PLMN.

The CRS-NSSAI may also be a representation of a NSSAI that the NAS layer wants to request, in other words, the CRS-NSSAI may represent a Requested NSSAI that the NAS layer wants to send. However, the NAS layer may wait to send the Requested NSSAI until the AS, e.g. RRC layer, indicates that a cell has been selected that can provide access to the slices in the CRS-NSSAI. If the RRC Layer indicates that a cell that can provide access to the slices in the CRS-NSSAI cannot be selected, the NAS Layer may provide an updated CRS-NSSAI with less or different S-NSSAI's. Alternatively, the NAS Layer may order the S-NSSAI's in the CRS-NSSAI in priority order and, once cell (re-)selection is completed, the RRC layer may provide the NAS layer with an indication of whether the selected cell supports each S-NSSAI in the CRS-NSSAI. The RRC Layer may have considered the priority information when performing cell (re-)selection.

An S-NSSAI may only be available part of the PLMN. Therefore, upper layers may provide an indication of the availability of the S-NSSAIs. For example, a field may be included in the CRS-NSSAI to indicate in which Tracking Area(s), RAN Notification Area(s) or cell(s) an S-NSSAI is available. Alternatively, the availability may be indicated in GPS coordinates or any other method used to convey location. The absence of such a field may be used to indicate the S-NSSAI is available throughout the Registration Area or throughout the entire PLMN.

An S-NSSAI may only be available on a specific frequency. Therefore, upper layers may provide an indication of the frequency on which an S-NSSAI is available. For example, a field may be included in the CRS-NSSAI to indicate the frequency (or frequencies) on which an S-NSSAI is available. The absence of such a field may be used to indicate the S-NSSAI is available on all frequencies.

A cell in a PLMN may only support a subset of the S-NSSAIs in the CRS-NSSAI. Therefore, upper layers may provide the AS with an indication of the priority of an S-NSSAIs to enable ranking of cells based on S-NSSAI availability, e.g. based on which slice are supported by the cell. For example, a field may be included in the CRS-NSSAI to indicate the priority of an S-NSSAI, e.g. High, Medium, Low. Alternatively, the priority of an S-NSSAI may be based on the Slice Service Type (SST), e.g. eMBB, URLLC, MIoT, V2X, where the priority of an SST may be specified per the standards or provided by upper layers. The absence of such a field may be used to indicate the S-NSSAI has a default priority. Alternatively, the field may correspond to flag that is used to indicate S-NSSAI(s) that are preferred or required to be available in a cell. In one example, the preferred or required S-NSSAIs correspond to Subscribed S-NSSAIs marked as a default S-NSSAI in the Subscription Information.

A summary of the exemplary fields that may be included in the CRS-NSSAI is shown in Table 2.

TABLE 2
Exemplary Fields of a CRS-NSSAI

| Field Name | Description |
|---|---|
| S-NSSAI | Identity of the network slice |
| Availability | List of TAs, RNAs or PCIs where the S-NSSAI |
| | is available |
| Frequency | Frequencies on which the S-NSSAI is available |
| Priority | Priority of the NSSAI |

Other fields, corresponding to additional slice-related information may also be included in the CRS-NSSAI, if provided by the network, e.g. slice load, slice resource availability, or other per slice QoS-related metric.

In other alternatives, RAN signaling; (e.g., System Information or dedicated signaling, such as an RRCRelease message) may be used to configure or override some or all of the CRS-NSSAI.

### Cell Categories

The cells may be categorized according to which services they offer. For slice-based cell (re-)selection, the UE may also consider the slices available in a cell when categorizing a cell.

Whether or not a cell is categorized as an “acceptable cell,” may be based, at least in part, on at least one S-NSSAI available in the cell allowing the UE to obtain limited service.

Whether or not a cell is categorized as a “suitable cell” may be based, at least in part, on the cell supporting specific S-NSSAIs in the CRS-NSSAI, e.g. S-NSSAIs marked as “required”, S-NSSAI(s) with the highest priority, S-NSSAI(s) with a priority that is above a threshold, etc. And in another example, a cell may be considered suitable if it supports at least one of the S-NSSAIs in the CRS-NSSAI.

For scenarios where slice-based barring is supported, whether or not a cell is categorized as a “barred” cell may be based, at least in part, on the S-NSSAIs in the CRS-NSSAI that are available in the cell being indicated as barred.

For scenarios where slice-based reservation is supported, whether or not a cell is categorized as a “reserved” cell may be based, at least in part, on the S-NSSAIs in the CRS-NSSAI that are available in the cell being indicated as reserved.

The following are exemplary cell category definitions that consider slice availability, such as acceptable cell, suitable cell, barred cell, or reserved cell,

Acceptable cell: An “acceptable cell” is a cell on which the UE may camp to obtain limited service (originate emergency calls and receive ETWS and CMAS notifications). Such a cell shall fulfil the following requirements, which is the minimum set of requirements to initiate an emergency call and to receive ETWS and CMAS notification in an NR network:

The cell is not barred;
At least one S-NSSAI supported in the cell would allow the UE to obtain limited service;
The cell selection criteria are fulfilled.

And in other alternatives, the acceptability of a cell may be determined, at least in part, on at least one S-NSSAI being from a subset of S-NSSAI, where the subset may be S-NSSAIs with priority above a certain value, or having some other relevant property of a slice.

Suitable cell: A cell is considered as suitable if the following conditions are fulfilled:
The cell is part of the selected PLMN or the registered PLMN or PLMN of the Equivalent PLMN list;
The cell selection criteria are fulfilled.

According to the latest information provided by NAS:
The cell is not barred;
The cell is part of at least one TA that is not part of the list of “Forbidden Tracking Areas” (TS 22.261 [3]), which belongs to a PLMN that fulfils the first bullet herein (e.g., cell is part of the selected PLMN or the registered PLMN or PLMN of the Equivalent PLMN list);
The cell supports the S-NSSAI(s) marked as “required” in the CRS-NSSAI;
The cell supports at least one S-NSSAI in CRS-NSSAI.

And in other alternatives, if a cell is associated with a slice-related metric, the suitability of a cell may be determined, at least in part, on the metric being above a certain value.

Barred cell: A cell is barred if it is so indicated in the system information, as specified in TS 38.331 [1] (3GPP TS 38.331, Radio Resource Control (RRC) protocol specification (Release 15), V15.8.0) or if the S-NSSAIs in the CRS-NSSAI that are supported in the cell are indicated as barred.

Reserved cell: A cell is reserved if it is so indicated in system information, as specified in TS 38.331 [1] or if the S-NSSAIs in the CRS-NSSAI that are supported in the cell are indicated as reserved.

### Slice-Based Cell Selection and Reselection Procedure

### States and State Transitions

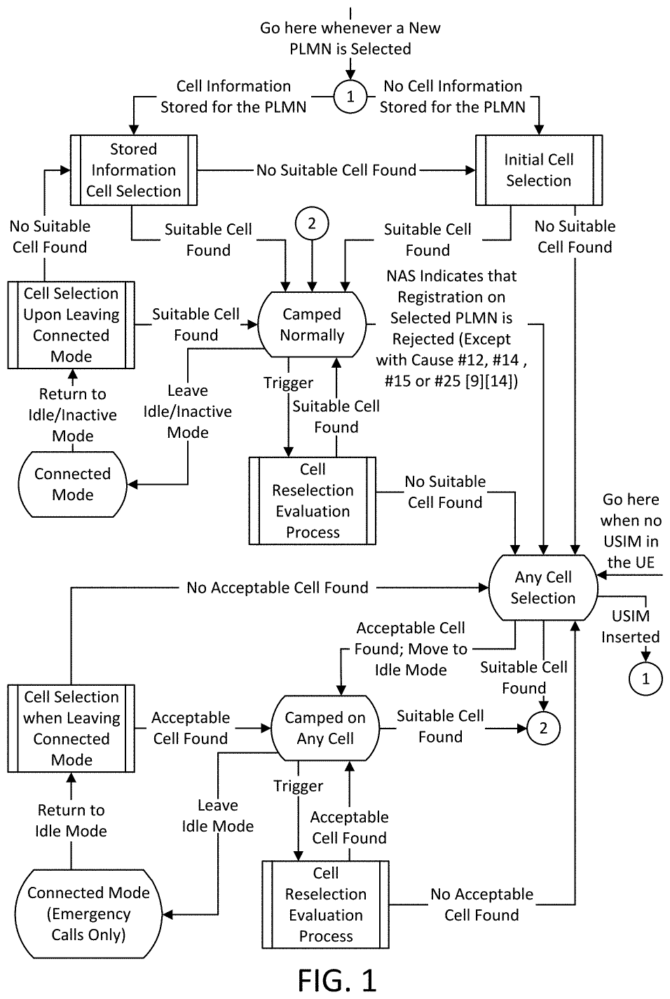

FIG. 1 shows the states and state transitions and procedures in RRC_IDLE and RRC_INACTIVE. Whenever a new PLMN selection is performed, it causes an exit to number 1.

### Cell Selection Process

The cell selection process may be performed by one of the following procedures. A first exemplary procedure may be associated with initial cell selection (no prior knowledge of which RF channels are NR frequencies) and provide for: 1) The UE shall scan RF channels in the NR bands according to its capabilities to find a suitable cell; 2) On each frequency, the UE need only search for the strongest cell, except when configured to perform slice-based cell selection, in which case the UE may search for additional cells based on the S-NSSAIs supported by the strongest cell(s); or 3) Once a suitable cell is found, this cell shall be selected. A second exemplary procedure may be associated with cell selection by leveraging stored information: 1) this procedure requires stored information of frequencies and may also information on cell parameters from previously received measurement control information elements or from previously detected cells; 2) Once the UE has found a suitable cell, the UE shall select it; and 3) If no suitable cell is found, the initial cell selection procedure in a) shall be started.

It is contemplated herein that priorities between different frequencies or RATs provided to the UE by system information or dedicated signalling may not be used in the cell selection process. However, priorities between different frequencies or RATs that are determined based on the CRS-NSSAI may be used in the cell selection process.

### Cell Selection Criterion

The cell selection criterion S is fulfilled as shown in Table 3, when:

```
TABLE 3
    Srxlev > 0 AND Squal > 0
where:
    Srxlev = Qᵣₓₗₑᵥₘₑₐₛ − (Qᵣₓₗₑᵥₘᵢₙ + Q_{rxlevminoffset} ) − P_{compensation} − Qoffsetₜₑₘₚ
    Squal = Q_{qualmeas} − (Q_{qualmin} + Q_{qualminoffset}) − Qoffsetₜₑₘₚ
where:
```

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 [1] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qrxlevmin is |
| | obtained from q-RxLevMinSUL, if present, in SIB1, SIB2 |
| | and SIB4, additionally, if Q_{rxlevminoffsetcellSUL} is present in |
| | SIB3 and SIB4 for the concerned cell, this cell specific |
| | offset is added to the corresponding Qrxlevmin to achieve |
| | the required minimum RX level in the concerned cell; |
| | else Qrxlevmin is obtained from q-RxLevMin in SIB1, |
| | SIB2 and SIB4, additionally, if Q_{rxlevminoffsetcell} is present in |
| | SIB3 and SIB4 for the concerned cell, this cell specific |
| | offset is added to the corresponding Qrxlevmin to achieve |
| | the required minimum RX level in the concerned cell. |
| Q_{qualmin} | Minimum required quality level in the cell (dB). |
| | Additionally, if Q_{qualminoffsetcell} is signalled for the |
| | concerned cell, this cell specific offset is added to achieve |
| | the required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122 [4] (3GPP 23.122, |
| | Non-Access-Stratum (NAS) functions related to Mobile |
| | Station (MS) in idle mode (Release 15), V15.7.0.) |
| Q_{qualminoffset} | Offset to the signalled Q_{qualmin} taken into account in the |
| | Squal evaluation as a result of a periodic search for a |
| | higher priority PLMN while camped normally in a |
| | VPLMN, as specified in TS 23.122 [4], |
| P_{compensation} | For FR1, if the UE supports the additionalPmax in the |
| | NR-NS-PmaxList, if present, in SIB1, SIB2 and SIB4: |
| | max(P_{EMAX1} −P_{PowerClass}, 0) − (min(P_{EMAX2}, P_{PowerClass}) − |
| | min(P_{EMAX1}, P_{PowerClass})) (dB); |
| | else: |
| | max(P_{EMAX1} −P_{PowerClass}, 0) (dB) |
| | For FR2, P_{compensation} is set to 0. |
| P_{EMAX1}, P_{EMAX2} | Maximum TX power level of a UE may use when |
| | transmitting on the uplink in the cell (dBm) defined as |
| | P_{EMAX} in TS 38.101 [8] (3GPP TS 38.101, NR; User |
| | Equipment (UE) radio transmission and reception; Part 1: |
| | Range 1 Standalone (Release 15), V15.8.2). If UE |
| | supports SUL frequency for this cell, P_{EMAX1} and P_{EMAX2} |
| | are obtained from the p-Max for SUL in SIB1 and NR-NS- |
| | PmaxList for SUL respectively in SIB1, SIB2 and SIB4 as |
| | specified in TS 38.331 [1], else P_{EMAX1} and P_{EMAX2} are |
| | obtained from the p-Max and NR-NS-PmaxList |
| | respectively in SIB1, SIB2 and SIB4 for normal UL as |
| | specified in TS 38.331 [1]. |
| P_{PowerClass} | Maximum RF output power of the UE (dBm) according |
| | to the UE power class as defined in TS 38.101-1 [8]. |

The signaled values Q_{rxlevminoffset} and Q_{qualminoffset} are only applied when a cell is evaluated for cell selection as a result of a periodic search for a higher priority PLMN while camped normally in a VPLMN (TS 23.122 [4]). During this periodic search for higher priority PLMN, the UE may check the S criteria of a cell using parameter values stored from a different cell of this higher priority PLMN.

An additional offset, e.g. Qoffset_{NSSAI}, that is based on which S-NSSAIs in the CRS-NSSAI are supported by a cell may be used when determining the S criteria. This may be referred to as S-NSSAI based cell selection criteria. In a first example, Qoffset_{S-NSSAI,i} is defined as follows:

$${Qoffset}_{NSSAI} = {\sum }_{i} {Qoffset}_{S - NSSAI , i}$$

where Qoffset_{S-NSSAI,i} corresponds to an offset that is added based on the availability of the i^{th} S-NSSAI in the cell. Qoffset_{S-NSSAI,i} may be configured by higher layers, e.g. as a corresponding field for each S-NSSAI in the CRS-NSSAI. Alternatively, Qoffset_{S-NSSAI,i} may be determined based on the SDT or SD fields of an S-NSSAI included in the CRS-NSSAI. And in yet another alternative, Qoffset_{S-NSSAI,i} may correspond to the same value for the slices. Qoffset_{S-NSSAI,i} may be a positive value when the corresponding slice is available in the cell, thereby making the cell more favorable for cell selection; or a negative value when the corresponding slice isn't available in the cell. Such an approach allows a UE to be simultaneously steered towards cells that support specific S-NSSAIs and away from cells that don't support specific S-NSSAIs. Alternatively, a non-zero value may only be used in one of the cases, e.g. when the S-NSSAI is available or absent. Such an approach may allow a UE to be steered towards cells that support specific S-NSSAIs or away from cells that don't support specific S-NSSAIs. Other alternatives, where the offset may depend on other properties of a slice, e.g. priority of the i^{th} slice, can also be envisaged.

The slice-based Srxlev and Squal values may be defined as follows:

Srxlev=Qᵣₓₗₑᵥₘₑₐₛ−(Qᵣₓₗₑᵥₘᵢₙ+Q_{rxleminoffset})−P_{compensation}−Qoffsetₜₑₘₚ+Qoffset_{NSSAI}

Squal=Q_{qualmeas}−(Q_{qualmin}+Q_{qualminoffset})−Qoffsetₜₑₘₚ+Qoffset_{NSSAI}

### Cell Reselection Evaluation Process

### Reselection Priorities Handling

Absolute priorities of different NR frequencies or inter-RAT frequencies may be determined, at least in part, by the S-NSSAIs that are available on that frequency. This may be referred to as S-NSSAI based reselection priorities handling. The priority of an S-NSSAI and the frequency (or frequencies) on which an S-NSSAI is available may be provided in the CRS-NSSAI as described herein. A default priority, e.g. the lowest priority, may be assumed for S-NSSAIs for which a priority is not explicitly provided. And for scenarios where none of the S-NSSAIs are provided with a frequency, the UE may assume S-NSSAI based reselection priority handling is not configured for that frequency.

In one example, the priority of a frequency is equal to the priority of the S-NSSAI with the highest priority on that frequency. For scenarios where two frequencies have the same priority, the number of S-NSSAIs configured with that priority may also be considered when determining the priority of a frequency, e.g. a frequency configured with x S-NSSAIs at priority P would be considered a higher priority than a frequency configured with y S-NSSAIs at priority P, assuming x>y. Alternatively, the priority of a frequency may correspond to the average of the priorities of the S-NSSAIs on that frequency. And in another example, the priority of a frequency may correspond to a count of the S-NSSAIs on that frequency, e.g. a frequency where 1 S-NSSAI is configured would have a priority of 1, a frequency where 2 S-NSSAIs are configured would have a priority of 2, etc.

In another example, a frequency may be associated with a NSSAI metric, which may be a sum of terms, where each term corresponds to an S-NSSAI. The term may depend on the S-NSSAI priority. For example, the metric is the sum of the priorities of the S-NSSAIs on the frequency.

### Measurement Rules for Cell-Reselection

Rules used by the UE to limit cell reselection measurements may consider which S-NSSAIs are available in the Serving Cell. For example, if the Serving Cell fulfills Srxlev>S_{IntraSearchP} and Squal >S_{intraSearchQ}; and the S-NSSAIs in the CRS-NSSAI are available in the Serving Cell, the UE may choose not to perform intra-frequency measurements. Other examples for the aspect of the rule that considers which S-NSSAIs are available in the Serving Cell may be based on one or more of the following: 1) the required S-NSSAIs being available in the Serving Cell; 2) the high priority S-NSSAIs being available in the Serving cell; or 3) the S-NSSAIs with a priority above a threshold being available in the Serving Cell. Other aspects of the rule may be based, at least in part, on an NSSAI-related metric being above a certain value.

When to perform inter-frequency and inter-RAT measurements may also be dependent on which S-NSSAIs in the CRS-NSSAI are available in the Serving Cell or on another frequency. For example, if a higher priority S-NSSAI that is not available in the Serving Cell is available on another frequency (or frequencies), the UE shall perform measurements of that frequency (or frequencies). Other examples may be based on one or more of the following: if the required S-NSSAI(s) are not available on the Serving Cell, but are available on a frequency other than the current frequency; or if one or more S-NSSAIs are not available in the Serving Cell, but the S-NSSAIs are available on a frequency other than the current frequency.

For scenarios where S-NSSAI based reselection priorities handling as defined herein is used, the reselection priority of a given frequency is a function of the S-NSSAI availability. In this case, rules for determining when to perform inter-frequency and inter-RAT measurements may be based on the reselection priority of a given frequency as follows:
For a NR inter-frequency or inter-RAT frequency with a reselection priority higher than the reselection priority of the current NR frequency, the UE performs measurements of higher priority NR inter-frequency or inter-RAT frequencies.
For a NR inter-frequency with an equal or lower reselection priority than the reselection priority of the current NR frequency and for inter-RAT frequency with lower reselection priority than the reselection priority of the current NR frequency:
   If the serving cell fulfils Srxlev>S_{nonIntraSearchP} and Squal >S_{nonIntraSearchQ}, the UE may choose not to perform measurements of NR inter-frequencies or inter-RAT frequency cells of equal or lower priority;
   Otherwise, the UE shall perform measurements of NR inter-frequencies or inter-RAT frequency cells of equal or lower priority.
      Cells with Cell Reservations, Access Restrictions or Unsuitable for Normal Camping

For the highest ranked cell (including serving cell) according to cell reselection criteria and for the best cell according to absolute priority reselection criteria, the UE shall check if access is restricted according to the Slice-Based Cell Status and Cell Reservations subject matter described herein.

If that cell and other cells have to be excluded from the candidate list, the UE shall not consider these as candidates for cell reselection. This limitation shall be removed when the highest ranked cell changes or the CRS-NSSAI changes.

For scenarios where a cell is not suitable due to S-NSSAI availability, the UE may exclude the cell as a candidate for reselection for a duration of time, where the actual duration of time or the maximum duration of time may be specified per the standard or dynamically configured, e.g. up to 300 seconds. For scenarios where the cells on a given frequency layer in the UEs Registration Area are configured with the same S-NSSAI, e.g. are configured to support the same slices, the UE may exclude cells on the same on the same frequency as candidates for cell reselection. Any limitation that is configured may be removed upon a state transition, e.g. if the UE enters into the “Any Cell Selection” state.

### NR Inter-Frequency and Inter-RAT Cell Reselection Criteria

For scenarios where S-NSSAI based reselection priorities handling as defined herein is used, the reselection priority of a given frequency is a function of the S-NSSAI availability or NSSAI related metrics. In this case, cell reselection to a frequency other than the serving frequency can be based on the cell selection Received (RX) signal level, e.g. Srxlev, or the cell selection quality, e.g. Squal. Which quantity is used may be under network control and configured via broadcast or dedicated signaling. NSSAI-based reselection priority handling may use one or more of the following:
Cell reselection to a higher priority frequency may be based on the Srxlev (or Squal) for a cell of a higher priority frequency exceeding a threshold.
Cell reselection to a cell on an equal priority frequency may be based on the “Intra-frequency and Equal Priority Inter-Frequency Cell Reselection Criteria” subject matter described herein.
Cell reselection to a cell on a lower priority frequency may be based on the Srxlev (or Squal) for the serving cell being below a threshold and Srxlev (or Squal) for a cell of a lower priority frequency exceeding a threshold.

Cell reselection to a higher priority frequency shall take precedence over a lower priority frequency if multiple cells of different priorities fulfill the cell reselection criteria. If more than one cell meets the cell reselection criteria, the UE may reselect a cell as follows:
If the highest-priority frequency is an NR frequency, the highest ranked cell among the cells on the highest priority frequency(ies) meeting the criteria according to “Intra-frequency and Equal Priority Inter-Frequency Cell Reselection Criteria” subject matter described herein.
If the highest-priority frequency is from another RAT, the strongest cell among the cells on the highest priority frequency(ies) meeting the criteria of that RAT.

### Intra-frequency and Equal Priority Inter-Frequency Cell Reselection Criteria

The cell-ranking criterion Rs for serving cell and Rn for neighboring cells is defined by the following as in Table 4:

```
TABLE 4
  Rs = Q_{meas,s} +Q_{hyst} − Qoffsetₜₑₘₚ
  Rn = Q_{meas,n} −Qoffset − Qoffsetₜₑₘₚ
where:
```

| | |
|---|---|
| Qmeas | RSRP measurement quantity used in cell |
| | reselections. |
| Qoffset | For intra-frequency: Equals to Qoffset_{s,n}, if Qoffset_{s,n} |
| | is valid, otherwise this equals to zero. |
| | For inter-frequency: Equals to Qoffset_{s,n} plus |
| | Qoffset_{frequency}, if Qoffset_{s,n} is valid, otherwise this |
| | equals to Qoffset_{frequency}. |
| Qoffsetₜₑₘₚ | Offset temporarily applied to a cell as specified in |
| | TS 38.331 [1]. |

The UE performs ranking of cells that fulfill the cell selection criterion S. The cells are ranked according to the R criteria by deriving Q_{meas,n} and Q_{meas,s} and calculating the R values using the RSRP results.

The UE may be configured to perform slice-based cell reselection. When slice-based cell reselection is configured, the UE considers which S-NSSAIs in the CRS-NSSAI are available in the candidate cells. Configuration of the CRS-NSSAI may imply that slice-based cell reselection in configured. Alternatively, slice-based reselection may be configured explicitly by higher layers, e.g. the NAS may set/clear a flag to indicate slice-based reselection is enabled/disabled.

When slice-based cell reselection is configured, the UE may perform cell reselection to the cell that supports the highest number of S-NSSAIs from the CRS-NSSAI. In another example, the UE may perform cell reselection to the cell that supports the highest number of required S-NSSAIs from the CRS-NSSAI. And in other examples, the cell reselection decision UE may be based on the priorities of the S-NSSAIs available in a cell, e.g. the UE may perform cell reselection to the cell supporting the highest priority S-NSSAI or the highest number of S-NSSAIs configured with the highest priority if multiple S-NSSAIs are configured with the same priority; or the UE may perform cell reselection to the cell based on a metric that corresponds to the sum or weighted sum of the priorities of the available S-NSSAIs, where the weights may be configurable or based on other slice-related info, e.g. per-slice load/resource availability in a cell, etc. For these examples, if there are multiple such cells, the UE performs cell reselection to the highest ranked cell among them.

In another alternative, an offset, e.g. Qoffset_{NSSAI}, that is based on which S-NSSAIs in the CRS-NSSAI are available in the serving and neighboring cells may be used when determining the R criteria. In a first example, Qoffset_{S-NSSAI,i} is defined as follows:

$${Qoffset}_{NSSAI} = {\sum }_{i} {Qoffset}_{S - NSSAI , i}$$

where Qoffset_{S-NSSAI,i} corresponds to an offset that is added based on the availability of the i^{th} S-NSSAI in the cell. Qoffset_{S-NSSAI,i} may be configured by higher layers, e.g. as a corresponding field for each S-NSSAI in the CRS-NSSAI. Alternatively, Qoffset_{S-NSSAI,i} may be determined based on the SDT or SD fields of an S-NSSAI included in the CRS-NSSAI. And in yet another alternative, Qoffset_{S-NSSAI,i} may correspond to the same value for the slices. Qoffset_{S-NSSAI,i} may be a positive value when the corresponding slice is available in the cell, thereby making the cell more favorable for cell reselection; or a negative value when the corresponding slice isn't available in the cell. Such an approach allows a UE to be simultaneously steered towards cells that support specific S-NSSAIs and away from cells that don't support specific S-NSSAIs. Alternatively, a non-zero value may only be used in one of the cases, e.g. when the S-NSSAI is available or absent. Such an approach allows a UE to be steered towards cells that support specific S-NSSAIs or away from cells that don't support specific S-NSSAIs. Other alternatives, where the offset may depend on other properties of a slice, e.g. priority of the i^{th} slice, can also be envisaged.

The slice-based cell-ranking criterion Rs for serving cell and Rn for neighboring cells may be defined as follows in Table 5:

```
TABLE 5
  Rs = Q_{meas,s} + Q_{hyst} + Qoffset_{NSSAI} − Qoffsetₜₑₘₚ
  Rn = Q_{meas,n} + Qoffset_{NSSAI} − Qoffset − Qoffsetₜₑₘₚ
where:
```

| | |
|---|---|
| Qmeas | RSRP measurement quantity used in cell |
| | reselections. |
| Qoffset | For intra-frequency: Equals to Qoffset_{s,n}, if |
| | Qoffset_{s,n} is valid, otherwise this equals to |
| | zero. |
| | For inter-frequency: Equals to Qoffset_{s,n} |
| | plus Qoffset_{frequency}, if Qoffset_{s,n} is valid, |
| | otherwise this equals to Qoffset_{frequency}. |
| Qoffsetₜₑₘₚ | Offset temporarily applied to a cell as |
| | specified in TS 38.331 [1], |
| Qoffset_{NSSAI} | Offset based on which S-NSSAIs in the CRS- |
| | NSSAI are available in the candidate cells. |

Alternatively, Qoffset_{NSSAI} may be included in one of the other offsets. For RS, Qoffset_{S-NSSAI} may be added to Qhyst; and for Rn, Qoffset_{S-NSSAI,i} may be subtracted from Qoffset, assuming a positive values of Qoffset_{S-NSSAI,i} imply a slice is available and negative values imply a slice is not available.

For scenarios where slices are deployed on specific frequency layers, Rn may be defined such that Qoffset_{NSSAI} is only be applied for inter-frequency cells that support a different set of S-NSSAIs than the serving cell.

Mechanisms to avoid ping-ponging between cells may also be defined. For example, the UE may only reselect the new cell if the following conditions are met: 1) The new cell is better than the serving cell according to the cell reselection criteria specified during a time interval Treselection_{RAT}; or 2) more than 1 second has elapsed since the UE camped on the current serving cell.

In the examples herein, if the cell is found to be not-suitable, the cell may be not considered a candidate for cell reselection in accordance with the “Cells with Cell Reservations, Access Restrictions or Unsuitable for Normal Camping” described herein.

### Cell Reselection Parameters in System Information Broadcasts

Slice-based cell reselection parameters may be broadcast in system information or configured via dedicated signaling. Slice-based cell reselection parameters may include, but are not limited to hysteresis values, offsets or thresholds that are used when calculating the S and R criterion while performing slice-based cell (re-)selection. The slice-based cell reselection parameters may be broadcast in addition to the cell-based parameters, in which case, they may be used to override the cell-based values. Alternatively, the slice-based parameters may also include new parameters that are only applicable for slice-based cell reselection. Slice-related info such as load, resource availability, QoS information, etc. may also be broadcast.

### Camped Normally State

The Camped Normally state is applicable for UEs in RRC_IDLE and RRC_INACTIVE. When camped normally, the UE acquires relevant System Information, monitors for Short Messages transmitted with P-RNTI over DCI and monitors for paging. The UE also performs measurements necessary for the cell reselection evaluation procedure. A UE in this state may execute the cell reselection evaluation procedure according to UE internal triggers and when information on the BCCH used for the cell reselection evaluation procedure has been modified. In addition to defining UE internal triggers so as to meet performance as specified in TS 38.133 [9] (3GPP TS 38.133, NR; Requirements for support of radio resource management (Release 15), V15.8.0), UE internal triggers may also be based on the S-NSSAI based cell selection criteria described herein. Reconfiguration/updating of the CRS-NSSAI may also trigger execution of the cell reselection procedure. For example, a change in the set of S-NSSAIs in the CRS-NSSAI may trigger the cell reselection evaluation procedure such that the UE searches for a more suitable cell to camp on.

### Selection of Cell at Transition to RRC_IDLE or RRC_INACTIVE State

The RRCRelease message is used by the network to transition the UE to RRC_IDLE or RRC_INACTIVE. The RRCRelease message may include information that can be used to control the slice-based cell selection and reselection behavior of the UE, which may be used to “steer” the UE towards cells that support specific S-NSSAIs or to “offload” the UE to specific cells or frequency layers.

For example, the network may redirect the UE to a specific carrier based on the UE's NSSAI, e.g. CRS-NSSAI, Allowed NSSAI, Configured NSSAI, etc.

In another example, the network may provide the UE with a reselection priority for one or more frequencies, where the priority of a given frequency may be based on the S-NSSAIs available on that frequency and the UE's NSSAI. The cell reselection priorities provided in the RRCRelease message may be used to override the reselection priorities determined by the UE indefinitely or for a fixed duration, e.g. until timer T320 expiration.

In another example, the network may deprioritize a frequency (or frequencies), where the determination of which frequency (or frequencies) to deprioritize may be based on the S-NSSAIs available on a given frequency and the UE's NSSAI. The deprioritization of a frequency (or frequencies) provided in the RRCRelease message may be used to override the reselection priority determined by the UE for the corresponding frequency (or frequencies) indefinitely or for a fixed duration, e.g. until timer T325 expiration.

In another example, the network may use the RRCRelease message to update or override the UE's Allowed or Configured NSSAI. In one aspect of this example, the RRCRelease message is used to add/remove one or more S-NSSAIs in the CRS-NSSAI. For an S-NSSAI that is being added, the RRCRelease messages may also include additional fields describing the attributes of the S-NSSAI, such as those in Table 2. In another aspect of the example, the RRCRelease message is used to update one or more of the of the attributes associated with an S-NSSAI in the CRS-NSSAI. The information provided in the RRCRelease message may be used to replace some or all of the CRS-NSSAI or to override the existing CRS-NSSAI for a fixed duration of time, e.g. until expiration of a timer whose duration is set to a value signaled in the RRCRelease message.

At reception of RRCRelease message to transition the UE to RRC_IDLE or RRC_INACTIVE, the UE shall attempt to camp on a suitable cell according to redirectedCarrierInfo if included in the RRCRelease message. If the UE cannot find a suitable cell, the UE is allowed to camp on any suitable cell of the indicated RAT. If the RRCRelease message does not include the redirectedCarrierInfo, the UE shall attempt to select a suitable cell on an NR carrier. If no suitable cell is found, the UE shall perform cell selection using stored information in order to find a suitable cell to camp on.

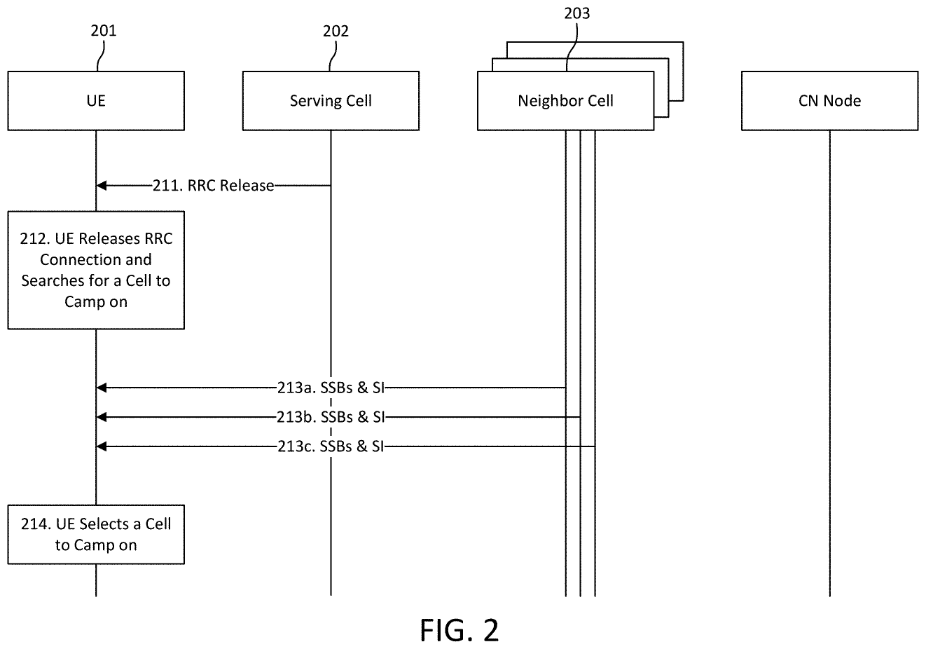

FIG. 2 is an illustration of how the RRCRelease message may be used to enable network control of the slice-based cell (re-)selection behavior of a UE 201. In FIG. 2. At step 211, UE 201 receives an RRCRelease message that includes information to steer” the UE 201 towards cells that support specific S-NSSAIs. At step 212, the UE 201 releases the RRC connection and begins searching for a suitable cell to camp on in accordance with the information provided in the RRCRelease message. At step 213a-step 213c, the UE 201 performs measurements of neighbor cells 203, ranks the cells that fulfill the S criteria, or reads the SI of one or more neighbor cells 203 to determine the suitability of the neighbor cell(s) 203. At step 214, UE 201 selects a suitable cell to camp on in accordance with the slice-based cell (re-) selection subject matter described herein.

The RRCRelease message may be used to “steer” the UE 201 towards cells that support specific S-NSSAIs or to “offload” the UE 201 to specific cells or frequency layers and may indicate to the UE 201 that the RRCRelease Message was sent because the UE 201 is not permitted to access the resources of a certain slice at the current time. The slice will be identified with an S-NSSAI's. Reception of this message may cause the UE 201 to select a different cell, handover to a different cell, to terminate any PDU Sessions that are associated with the slice and to de-register from the slice. Deregistration from the slice is achieved by sending a NAS Layer Registration message to the network with a Requested NSSAI that does not include the S-NSSAI of the slice that the UE 201 is de-registering from.

### Any Cell Selection State

The Any Cell Selection state is applicable for UEs in RRC_IDLE and RRC_INACTIVE. When in this state, the UE 201 performs the cell selection process to find a suitable cell to camp on. If the cell selection process fails to find a suitable cell after a complete scan of RATs and frequency bands supported by the UE 201, the UE 201 may attempt to find an acceptable cell of any PLMN to camp on, trying RATs that are supported by the UE 201 and searching first for a high-quality cell.

The CRS-NSSAI may be PLMN specific. When attempting to find an acceptable cell of any PLMN, the CRS-NSSAI may be updated to be based on the Configured NSSAI for the PLMN on which the UE 201 is searching for an acceptable cell. If no Configured NSSAI has been provided for a the PLMN on which the UE 201 is searching for an acceptable cell, the CRS-NSSAI may be updated to be based on a Default Configured NSSAI that applies to any PLMN.

Alternatively, the CRS-NSSAI may include a mapping of S-NSSAIs for the HPLMN to S-NSSAIs for the PLMN on which the UE 201 is searching for an acceptable cell.

And in another alternative, slice-based cell selection may be disabled when attempting to find an acceptable cell of any PLMN while in this state.

### Camped on Any Cell State

The Camped on Any Cell state is only applicable for UEs in RRC_IDLE. When in this state, the UE 201 acquires relevant System Information, monitors for Short Messages transmitted with P-RNTI over DCI. The UE 201 also performs measurements necessary for the cell reselection evaluation procedure. A UE 201 in this state may execute the cell reselection evaluation procedure according to UE 201 internal triggers and when information on the BCCH used for the cell reselection evaluation procedure has been modified. In addition to defining UE 201 internal triggers so as to meet performance as specified in TS 38.133 [9], UE 201 internal triggers may also be based on the S-NSSAI based cell selection criteria described herein. Reconfiguration/updating of the CRS-NSSAI may also trigger execution of the cell reselection procedure. A UE 201 in this state may also regularly attempt to find a suitable cell trying the frequencies of the RATs that are supported by the UE 201. If a suitable cell is found, the UE 201 transitions to the Camped Normally state. If the UE 201 supports voice services and the current cell does not support IMS emergency calls as indicated by the field ims-EmergencySupport in SIB1, the UE 201 performs cell selection/reselection to an acceptable cell that supports emergency calls in any supported RAT regardless of priorities provided in system information from current cell, if no suitable cell is found.

### Slice Registration Area

It may be desirable for network operators to configure the network such that certain slices are only available via a subset of the cells in the PLMN. It might not be practical to give the UE 201 a complete list of cells where a given slice is available, therefore, the UE 201 may be informed of the availability of a network slice within in a subset of the cells in the PLMN. The network may determine the subset of cells based on the proximity of the cells to the UEs location. For example, the network may inform the UE 201 of the availability of a network slice for cells that comprise the UEs Registration Area. This may be referred to as the Slice Registration Area for a given network slice.

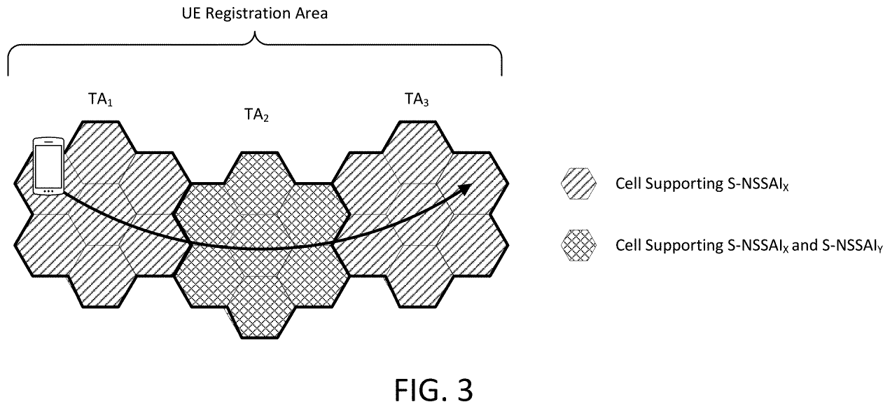

A given network slice may be available in 0 or more cells within the UEs Registration Area. FIG. 3 is an exemplary network deployment that shows a UE's Registration Area where a first slice (e.g., S-NSSAIₓ), may be available in the cells of the UE's Registration Area and a second slice, e.g. S-NSSAI_{y}, is available in a subset of the cells in the UE's Registration Area. In this example, the network slice availability is the same throughout a given TA, therefore the UE 201 may determine if a cell supports a specific network slice based on the Tracking Area Code broadcast in SIB1. The same concepts may also be applied for RNAs if the network slice availability is the same throughout a given RNA, e.g. the UE 201 may determine if a cell supports a specific network slice based on the RAN Area Code broadcast in SIB1.

The UE 201 may inform the network when it moves in/out of a Slice Registration Area. In one example, a Mobility Registration Update procedure may be used to inform the network of a change in the Slice Registration Area(s). Information related to the Slice Registration Area(s) in which the UE 201 is located may then be used by the network to determine which PDU sessions can be supported by a UE 201 at a given time. For example, if a UE 201 is registered to an S-NSSAI supporting a specific PDU session or sessions, but the UE 201 is not located in a Slice Registration Area that supports that S-NSSAI, the network may “suspend” the PDU sessions(s) associated with that S-NSSAI. The UE 201 may be informed that the PDU sessions and the UE's activity in the slice (e.g., S-NSSAI) are suspended in the Registration Response or in a subsequent PDU Session Modification procedure.

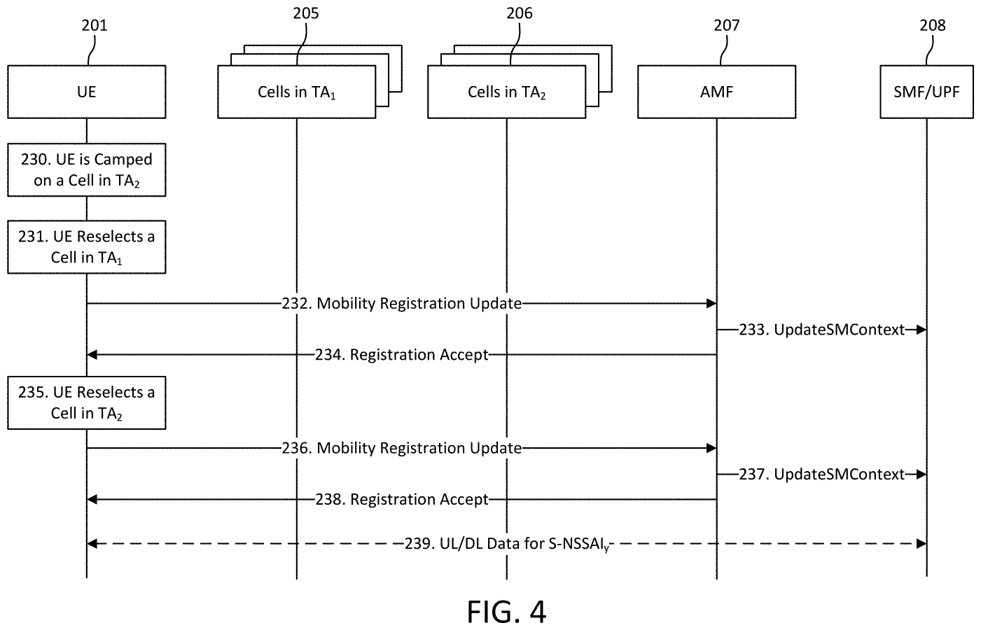

FIG. 4 is an illustration of such a procedure. In this example, we assume cells 205 in TA₁ support S-NSSAIₓ and cells 206 in TA₂ support S-NSSAIₓ and S-NSSAI_{y}, as shown in FIG. 3. Below are exemplary steps for FIG. 4, in which, as with other methods herein, some steps may not need to be executed (e.g., step 239 of FIG. 4). At step 230, the UE 201 is camped on a cell 206 in TA₂. At step 231, the UE 201 reselects a cell 205 in TA₁. At step 232, the UE 201 performs a Mobility Registration Update procedure to inform the network that it has moved to a TA that supports a different set of RAN slices, e.g. S-NSSAI_{y} is not available. At step 233, the AMF 207 invokes the SMF's UpdateSMContext service to inform the SMF that the UE 201 is not able to transmit/receive data for PDU sessions associated with slices that are not available, e.g. PDU sessions associated S-NSSAI_{y}. The SMF/UPF 208 may buffer or drop DL data that arrives for PDU sessions associated with S-NSSAI_{y}. At step 234, the AMF 207 sends a Registration Accept message to the UE 201 and indicates to the UE 201 that PDU Sessions that are associated with the S-NSSAI that is not available are suspended or terminated. The Registration Accept may also include a timer that indicates that the PDU Session should be considered terminated if the UE 201 does not Re-Register with the network in a location where the S-NSSAI is allowed before the timer has expired.

With continued reference to FIG. 4, at step 235, the UE 201 reselects a cell 206 in TA₂. At step 236, the UE 201 performs a Mobility Registration Update procedure to inform the network that it has moved to a TA that supports a different set of RAN slices, e.g. 5-NSSAI_{y} is available. At step 237, the AMF 207 invokes the SMF's UpdateSMContext service to inform the SMF/UPF 208 that the UE 201 is able to transmit/receive data for PDU sessions associated with slices that are available, e.g. PDU sessions associated S-NSSAI_{y}. At step 238, the AMF 207 sends a Registration Accept message to the UE 201 and indicates to the UE 201 that PDU Sessions that are associated with the S-NSSAI that are no longer suspended. At step 239, the UE 201 commences with UL/DL data transmission and reception for PDU sessions associated with S-NSSAI_{y}, where the DL data may include any data that was buffered by the SMF/UPF 208 while the UE 201 was in TA₁. UL/DL data transmission and reception for PDU sessions associated with other S-NSSAIs supported in TA₂, e.g. S-NSSAIₓ, may also occur.

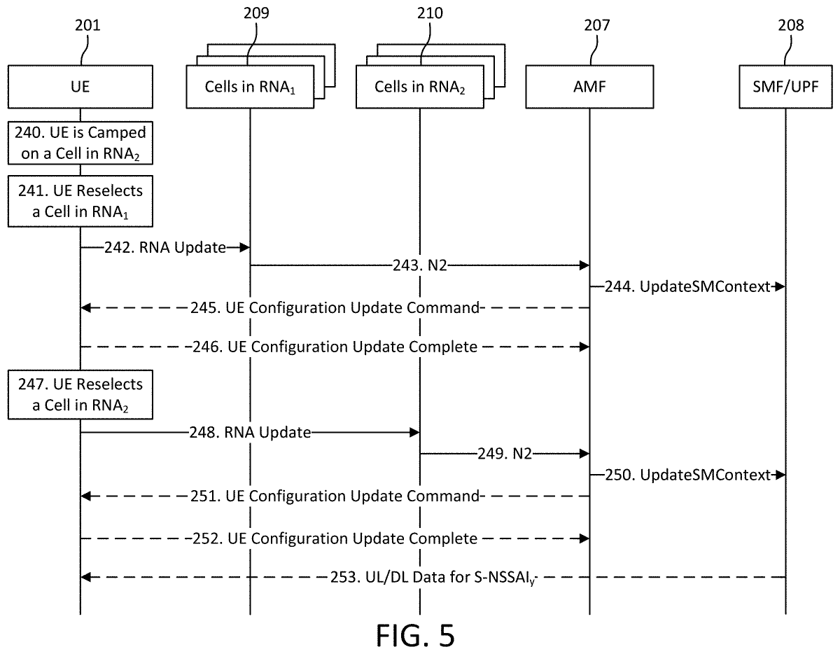

In another example, slice availability is defined at the RNA level. An RNA Update procedure, which is used to inform the network of a change in RAN, may also be used to inform the network of a change in Slice Registration Area(s). In this example, we assume cells in RNA₁ support S-NSSAIₓ and cells in RNA₂ support S-NSSAIₓ and S-NSSAI_{y}. FIG. 5 is an exemplary illustration of Slice Area Registration Update via RNA Update Procedure. Below are exemplary steps for FIG. 5, in which, as with other methods herein, some steps may not need to be executed (e.g., steps 11-13 of FIG. 5, among others). At step 240, the UE 201 is camped on a cell 210 in RNA₂. At step 241, the UE 201 reselects a cell 209 in RNA₁. At step 242, the UE 201 performs an RNA update procedure to inform the network that it has moved to RNA₁. At step 243, the RAN node, e.g., gNB in RNA₁, sends an N2 Message to inform the AMF 207 that the UE 201 has moved to a location that supports a different set of RAN slices, e.g., S-NSSAI_{y} is not available. At step 244, the AMF 207 invokes the SMF's UpdateSMContext service to inform the SMF 208 that the UE 201 is not able to transmit/receive data for PDU sessions associated with slices that are not available, e.g., PDU sessions associated S-NSSAI_{y}. The SMF/UPF 208 may buffer or drop DL data that arrives for PDU sessions associated with S-NSSAI_{y}.

With continued reference to FIG. 5, at step 245, the UE 201 receives a UE Configuration Update Command to inform the UE 201 that it should not transmit data for PDU sessions associated with S-NSSAI_{y}. Alternatively, the PDU Session Modification procedure may be triggered and used to inform the UE 201 that it should not transmit data for the PDU Sessions. A cause code associated with the procedure maybe used to indicate to the UE 201 that the PDU Session is suspended because of the UE 201's current location. At step 246, the UE 201 transmits a UE 201 Configuration Update Complete to confirm reception of the UE 201 Configuration Update message. At step 247, the UE 201 reselects a cell 210 in RNA₂. At step 248, the UE 201 performs an RNA update procedure to inform the network that it has moved to RNA₂. At step 249, the RAN node, e.g. gNB in RNA₂, sends an N2 Message to inform the AMF 207 that the UE 201 has moved to a location that supports a different set of RAN slices, e.g. 5-NSSAI_{y} is available.

At step 250, the AMF 207 invokes the SMF's UpdateSMContext service to inform the SMF/UPF 208 that the UE 201 is able to transmit/receive data for PDU sessions associated with slices that are available, e.g. PDU sessions associated S-NSSAI_{y}. At step 251, the UE 201 receives a UE Configuration Update Command to inform the UE 201 that it can transmit data for PDU sessions associated with S-NSSAI_{y}. Alternatively, the PDU Session Modification procedure may be triggered and used to inform the UE 201 that it may now transmit data for the PDU Sessions. A cause code associated with the procedure maybe used to indicate to the UE 201 that the PDU Session is suspended because of the UE 201's current location. At step 252, the UE 201 transmits a UE Configuration Update Complete to confirm reception of the UE Configuration Update message. At step 253, the UE 201 commences with UL/DL data transmission and reception for PDU sessions associated with S-NSSAI_{y}, where the DL data may include any data that was buffered by the SMF/UPF 208 while the UE 201 was in RNA₁. UL/DL data transmission and reception for PDU sessions associated with other S-NSSAIs supported in RNA₂, e.g. S-NSSAIₓ, may also occur.

### Slice-Aware RRC Connection Establishment/Resume

For scenarios where the UE 201 is camped on a cell that does not support the desired slice(s), e.g. the S-NSSAI(s) that the UE 201 anticipates that it might want to access, the UE 201 may reselect a cell that does support the desired slice(s) before commencing with the RACH procedure to establish/resume the RRC connection. We refer to this as a slice-aware RRC Connection Establishment/Resume procedure.

In the case of MO access, the UE 201 may determine the desired slice(s) based on the application/services for which data needs to be transmitted or the slices in the Allowed NSSAI. In one aspect of the disclosed subject matter, upper layers, e.g. the NAS Layer, informs the AS of the desired slice(s), e.g. S-NSSAIs, when making a request to establish/resume an RRC connection. Alternatively, this info may be conveyed by providing the UE 201 with info about the PDU session(s) for which data needs to be transmitted and the AS may then determine the desired slice(s). And in another alternative, the desired slice(s) may be determined by the AS based on the Logical Channel(s) (LCH) or Logical Channel Group(s) (LCG) that have data available for transmission.

In the case of MT access, the network may inform the UE 201 of the desired slice(s) when the UE 201 is paged. The desired slice(s) may correspond to S-NSSAIs in the Allowed NSSAI, that was provided to the UE 201 during a Registration procedure, an S-NSSAI in the Configured NSSAI, etc. In one aspect of the disclosed subject matter, the Paging Message includes the S-NSSAI(s) (or SST's or SD's) associated with the PDU session(s) for which data will be transmitted for the MT call. The S-NSSAI(s) included in the Paging Message may be used by the AS directly to determine the desired slice(s). Alternatively, the AS may forward the S-NSSAI(s) (or SST's or SD's) included in the Paging Message to upper layers, thereby enabling upper layers to determine the desired slice(s) and subsequently inform the AS of the desired slice(s), e.g. S-NSSAIs, when making a request to establish/resume an RRC connection.

Prior to commencing with the RACH procedure to establish/resume the RRC connection, the UE 201 compares the desired slice(s) with the slice(s) supported by the serving cell, where the UE 201 may determine which slices are supported by a cell using the “Slice-Based Cell Selection and Reselection” subject matter described herein. If the UE 201 determines the serving cell does not support the desired slice(s), the UE 201 may reselect a cell that does support the desired slice(s). For scenarios where the desired slices are not supported by a single cell, the UE 201 may rank the cells in accordance with “Slice-Based Cell Selection and Reselection” subject matter described herein.

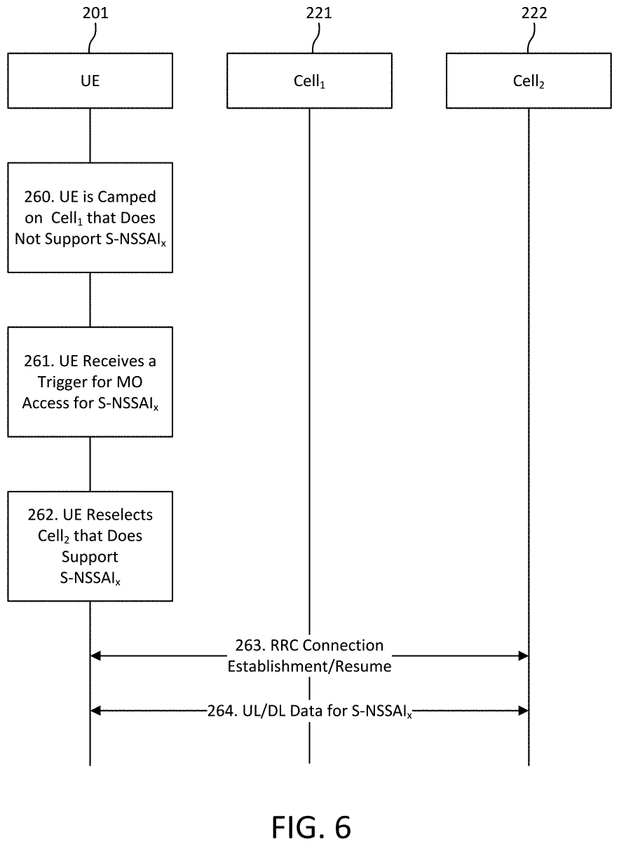

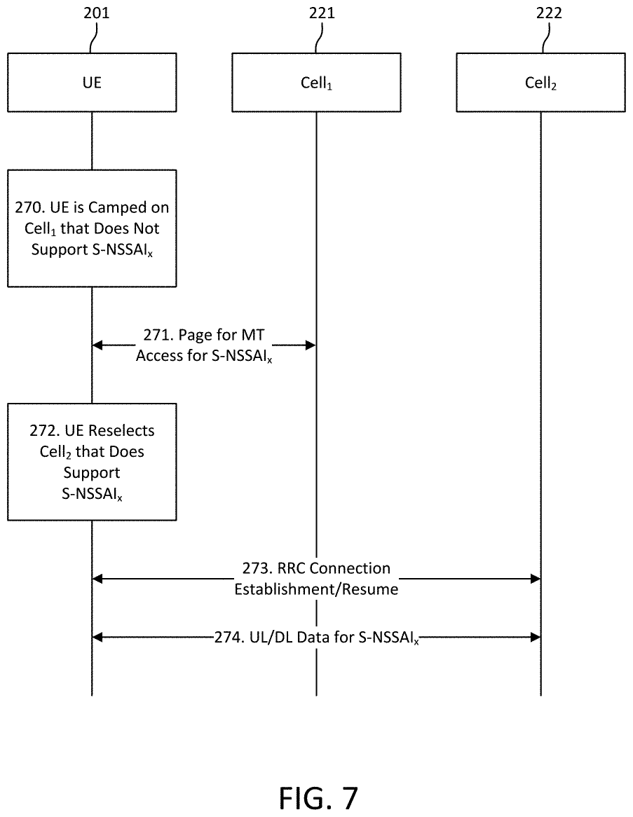

FIG. 6 and FIG. 7 are illustrations of the signaling for an exemplary Slice-Aware RRC Connection Establishment/Resume procedure for MO and MT access respectively. In these examples, we assume Cell₁ and Cell₂ cover the same geographic area, thereby allowing the UE 201 to camp on either cell at its current location. Furthermore, we also assume Cell₁ does not support the desired slice, e.g. S-NSSAIₓ, but, Cell₂ does. FIG. 6 is an exemplary illustration of Slice-Aware RRC Connection Establishment Procedure (MO Access). In FIG. 6, at step 260, the UE 201 camps on Cell₁ 221 that does not support S-NSSAIₓ. At step 261, the UE 201 receives a trigger for MO access for S-NSSAIₓ. Upper layers may provide the AS, e.g. RRC, with one or more S-NSSAIs that correspond to the desired slice(s) when making a request to establish or resume an RRC connection. For scenarios where the MO access is initiated by the AS layer, e.g. upon triggering an RNA update while the UE 201 is in RRC_INACTIVE, the AS, e.g. RRC, may determine the desired slice(s) with or without interaction with upper layers. In one aspect of the subject matter, it may be assumed that any slice can be used for RRC signaling initiated by the AS. Therefore, the UE 201 can commence with resuming the RRC connection on the serving cell, provided the UE 201 is camped normally.

At step 262, the UE 201 determines the serving cell, e.g. Cell₁, 221 does not support S-NSSAIₓ, e.g. the desired slice, and reselects Cell₂ 222 that does support S-NSSAIₓ At step 263, the UE 201 performs the RRC Connection Establishment/Resume procedure with Cell₂ 222. At step 264, the UE 201 commences with UL/DL data transmission for S-NSSAIₓ with Cell₂ 222.

FIG. 7 is an exemplary illustration of Slice-Aware RRC Connection Establishment Procedure (MT Access). In FIG. 7, at step 270, the UE 201 camps on Cell₁ 221 that does not support S-NSSAIₓ. At step 271, the UE 201 receives a Page for MT access for 5-NSSAIₓ. The Page may be initiated by the RAN or CN. The network may Page the UE 201 in one or more Tracking Areas, where the cells in a given Tracking Area that Page the UE 201 may or may not support the slice for which the MT access is intended, e.g. Cell₁ 221 and Cell₂ 222 in the current example may Page the UE. At step 272, the UE 201 determines the serving cell, e.g. Cell₁ 221, does not support S-NSSAIₓ, e.g. the desired slice, and reselects Cell₂ 222 that does support S-NSSAIₓ. The desired slice may be determined by the AS directly, e.g. from the S-NSSAI(s) included in the PagingRecord. Alternatively, the AS may forward the S-NSSAI(s) included in the PagingRecord to upper layers, thereby enabling upper layers to determine the desired slice(s) and subsequently inform the AS of the desired slice(s), e.g. S-NSSAI(s), when making a request to establish/resume an RRC connection in response to the Page. At step 273, the UE 201 performs the RRC Connection Establishment/Resume procedure with Cell₂ 222. At step 274, the UE 201 commences with UL/DL data transmission for S-NSSAIₓ with Cell₂ 222.

In another alternative, the UE 201 may simultaneously camp on multiple cells, and then access the cell that supports the desired slice. In one aspect of the subject matter, the UE 201 monitors slice-dependent paging on multiple different cells, and the network transmits a page corresponding to a given slice only on cells that support that slice.

Mechanisms Associated with Scenario #2

To allow offloading of initial access attempts for a given slice to a specific frequency layer, the UE 201 may reselect a cell on a different frequency layer prior to commencing with the RACH procedure to establish/resume the RRC connection, where the cell reselection priority of a given frequency may be determined, at least in part, on the slice for which the RRC connection is being established/resumed. The UE 201 may be provisioned or configured with a slice-specific priority for each frequency layer on which a given slice is available. For example, the Configured NSSAI may include fields to indicate the priority of an S-NSSAI for the frequencies on which the S-NSSAI is deployed. Prior to establishing/resuming an RRC connection, a cell reselection evaluation process is triggered, where the UE 201 calculates the NR Inter-frequency and Inter-RAT cell reselection criteria using the slice-specific frequency priorities that correspond to the slice for which the RRC connection is being established/resumed. Cell reselection to a cell on a different frequency layer is subsequently performed, if a suitable cell on a higher priority frequency layer is found.

In another example, only a portion of the initial access traffic for a given slice may be directed to a different frequency layer. The portion of traffic to redirect to a different frequency layer may be based on some criteria or rules, e.g., the number of users of a specific type (e.g. eMBB or URLLC users in the cell or system) or the ratio of eMBB/URLLC traffic or slice traffic, initial access attempt conditions, number of initial access attempt failures, etc. For example, if number of initial access attempt failures is large, e.g. larger than a threshold, then redirect more initial access traffic to a first frequency layer, F1, otherwise redirect less traffic to F1. If the number of initial access attempt failures is smaller than a threshold, then no redirect of initial access traffic is performed. The portion of redirected traffic may be configured or indicated in e.g., broadcast, system information, higher layer signaling, RRC signaling, etc.

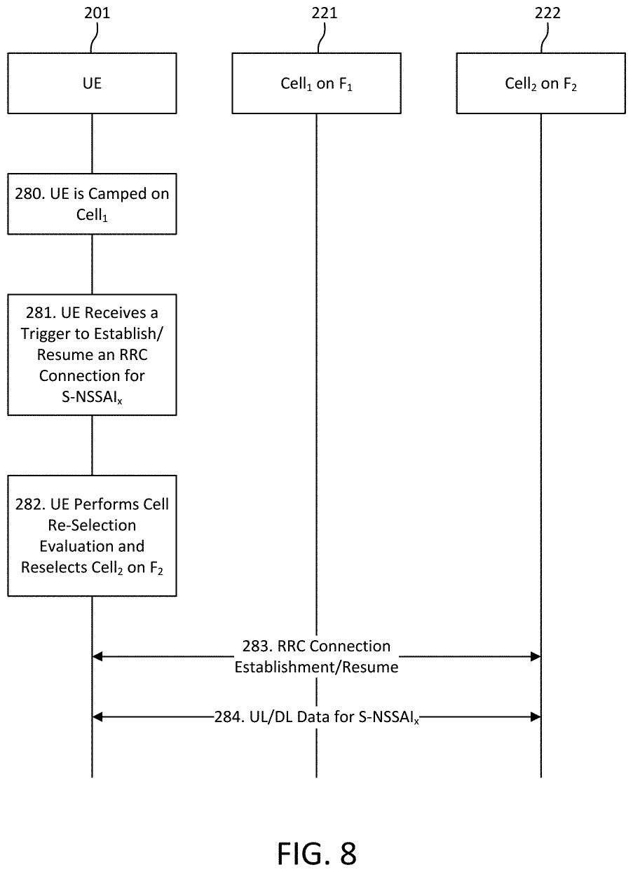

FIG. 8 is an exemplary illustration of a procedure for offloading initial access attempts for a given slice to a specific frequency layer. In this example, we assume Cell₁ and Cell₂ operate on F₁ and F₂ respectively. Furthermore, we also assume for S-NSSAIₓ, F₂ has a higher priority than F₁. In FIG. 8, at step 281, the UE 201 camps on Cell₁ 221 operating on F₁. At step 282, the he UE 201 receives a trigger to establish/resume an RRC connection for 5-NSSAIₓ. The trigger may correspond to a request from upper layers to suspend/resume an RRC connection for MO access or a Page from the network requesting the UE 201 to establish/resume an RRC connection for MT access. At step 283, the UE 201 performs Cell Re-Selection Evaluation and determines F₂ is higher priority than F₁ for S-NSSAIₓ and selects a suitable cell, Cell₂, 222 operating of F₂. At step 284, the UE 201 performs the RRC Connection Establishment/Resume procedure with Cell₂ 222. At step 285, the UE 201 commences with UL/DL data transmission for S-NSSAIₓ with Cell₂ 222.

Mechanisms Associated with Scenario #3

### Slice-Aware PLMN Selection

On request of the NAS, the UE 201 scans RF channels in the NR bands according to its capabilities to find available PLMNs. On each carrier, the UE 201 searches for the strongest cell and reads its system information, in order to find out which PLMN(s) the cell belongs. If the UE 201 can read one or several PLMN identities in the strongest cell, each found PLMN is reported to the NAS as a high quality PLMN (but without the RSRP value), provided that the following high-quality criterion is fulfilled: For an NR cell, the measured RSRP value shall be greater than or equal to −110 dBm.

Found PLMNs that do not satisfy the high-quality criterion but for which the UE 201 has been able to read the PLMN identities are reported to the NAS together with their corresponding RSRP values. The quality measure reported by the UE 201 to NAS shall be the same for each PLMN found in one cell.

To enable slice-aware PLMN selection, information that can be used to determine the slice availability for one or more PLMNs at the UEs current location may also be reported to the NAS. As discussed in the mechanisms associated with Scenario #1, network slice availability may be defined on a cell, RNA, TA, RA, or frequency layer basis. Therefore, this slice availability information (e.g., a list of available or barred slices, S-NSSAIs broadcast by the cell) may include the Cell Identity, Tracking Area Code, or RAN Area Code broadcast by the cell, the frequency of the cell, or other information. The information reported by the UE 201 to the NAS to determine slice availability is the same for each PLMN found in one cell.

The NAS may use the slice availability information, on its own or in combination with other information that may be reported by the UE, e.g. RSRP of the cell, when determining which PLMN to select. For example, the PLMN supporting the largest number of S-NSSAIs in the Configured NSSAI, Requested NSSAI, or Allowed NSSAI may be selected. Alternatively, the PLMN supporting the default NSSAI may be selected. Other alternatives, where the S-NSSAIs are ranked/prioritized, and the PLMN supporting the highest ranked/highest priority S-NSSAI(s) is selected can also be envisaged.

When PLMN selection is triggered, information about the desired slice(s), e.g. S-NSSAIs in the Configured NSSAI, S-NSSAIs in Requested NSSAI of the UEs next Registration Request, S-NSSAIs in the Allowed NSSAI, etc. may be used to control the search for available PLMNs. For example, the UE 201 may search for additional cells on a carrier based on the slices supported by the strongest cell(s), e.g. when slice-availability criterion such as the following is not fulfilled: 1) the cell supports the desired slice(s); 2) the cell supports a minimum number of desired slices; 3) the cell supports the default slice; or 4) the cell supports the highest ranked/highest priority slice(s).

Other alternatives, where the UE 201 considers slice-based metrics being above a certain value can also be envisaged.

Information about the desired slice(s) may also be used to control what information is reported to the NAS. For example, if the UE 201 can read one or several PLMN identities in the cell, each found PLMN is reported to the NAS (but without slice availability information), provided the slice-availability criterion as described herein is fulfilled.

Found PLMNs that do not satisfy the slice-availability criterion but for which the UE 201 has been able to read the PLMN identities may be reported to the NAS together with their corresponding slice availability information. Alternatively, such PLMNs may not be reported to the NAS.

The search for PLMNs may be stopped on request from the NAS. The UE 201 may optimise PLMN search by using stored information e.g. frequencies or also information on cell parameters from previously received measurement control information elements or information on slices supported by a cell.

Once the UE 201 has selected a PLMN, the cell selection procedure shall be performed in order to select a suitable cell of that PLMN to camp on.

Mechanisms Associated with Scenario #4

### Slice-Based Barring

During times of high network load, it is important to ensure that traffic for a lower priority slice does not block/delay the traffic that is associated with a higher priority slice. As part of the R17 study on enhancement of RAN slicing, RAN2 has agreed to “study mechanisms to enable UE 201 fast access to the cell supporting the intended slice, including slice based cell reselection under network control and slice based RACH configuration or access barring”.

As described herein, the 5G System already supports some Access Control Mechanisms that can be slice based, however, these mechanisms are limited in the sense that they present a configuration challenge for the network operator. They require each UE 201 to be configured, via NAS, with access category definitions for each slice that the operator might want to bar. Furthermore, the network operator needs to maintain a record of what definitions each UE 201 has been provisioned with so that the operator will know when and if updated definitions need to be sent to the UE.

The following issues should be addressed in order to improve the 5G system's support of slice-based access barring. First, what events, or conditions, should trigger the network to bar UEs from a slice. Second, what mechanism is used by the network to the indicate to the UE 201 that a slice is barred and how can this indication be sent to the UE 201 without requiring the operator to provision the UE 201 with operator specific access category definitions. Third, what should the UE's behavior be in response to learning that the UE 201 is barred from a slice.

Furthermore, it might not be necessary, or desirable, to apply barring equally to UE's within the slice. As described herein, the network can bar a UE 201 from accessing the network based on the UE's access identity, but it is not possible for the network to bar a UE 201 from particular slices based on a UE identity. For example, it might be necessary to only bar low priority UEs from accessing a slice while allowing higher priority UEs to access a slice. The following issues may be addressed in order to add support to the 5G system for UE, group, or class-based slice-based access barring: What criteria should be used by the network and the UE 201 to determine if a UE 201 is barred from a slice?

The subject matter in this section assume that the RAN node is responsible for informing the UE 201 that a slice is currently barred. A RAN node may be a gNodeB or a Non-3GPP InterWorking Function (N3IWF).

It should be appreciated that when a slice is barred, UEs that are currently registered in the slice may still be allowed to perform activity on the slice. Examples of activity are sending and receiving data and establishing and modifying PDU sessions. A UE 201 may be considered to be registered to a slice when the slice's S-NSSAI is in the UE's Allowed NSSAI and the UE 201 is in the RM-REGISTERED state. Barring may mean that the network should not allow the UE 201 to add the slice to the UE's Allowed NSSAI. Alternatively, when a slice is barred, it may mean that no activity or only certain types of activity are barred from happening in the slice. An example of certain types of activity may be sending and receiving data and establishing and modifying PDU sessions. Other examples of activity that may be barred include performing a Random Access Procedure to establish or resume an RRC connection. It should also be appreciated that when a slice is barred, the barring might only apply to some UEs. For example, the barring might only apply to certain types, classes, or groups of UE.

### Triggers for Slice-Based Barring

The RAN node may use internal logic to determine that barring should be active for a slice. The determination may be based observed conditions and on local configuration or configuration that was received from an OAM system. For example, the RAN node may determine that barring should be active for a slice when the RAN node observes that the amount of network resources that are currently being consumed by activity that is related to the slice is at, or above, a threshold. Furthermore, the RAN node might determine that the barring only applies to certain types, classes, or groups of UE.

The RAN node may use an indication from the OAM System or an AMF 207 to determine that barring should be active for a slice. For example, the RAN node may receive an indication from the OAM System or the AMF 207 about the state of the slice. Alternatively, the indication can come from any other network function that is responsible for monitoring the resource usage of a slice or enforcing limitations on how the resources of a slice are used. Examples of slice resources include PDU sessions and UE Registrations. The indication may indicate any of the following conditions: 1) First, the indication may indicate that the slice has reached a PDU session limit; or 2) Second, the indication may indicate that the slice has reached a UE Registration limit.

The indication that the slice is barred may include any combination of the following pieces of information. First, the indication may include an S-NSSAI that identifies the slice that is barred. Alternatively, only an SST or SD value may be provided to indicate to the RAN node that slices that share the SST or SD value are barred. Second, the indication may include UE identifiers or UE Group Identifiers to indicate to the RAN node the identities of the UE(s) that are barred from the slice. The absence of this information may indicate to the RAN node that the UEs are barred from accessing the slice. Third, the indication may include a cause for the barring condition. For example, the cause may indicate to the RAN node that the slice is barred because the slice has reached a limit in how many UEs are registered in the slice or the slice has reached a limit in how many PDU sessions are established within the slice. Fourth, the indication may include a time-out for the barring condition. The RAN node may assume that the barring state is no longer in place when the time-out is reached. The RAN node may use a timer to track whether the time out has been reached. If the RAN node receives a barring indication for the same slice before the time is reached, the RAN node may restart timer and continue the barring condition. Fifth, the types, classes, or groups of UE 201 that are barred, or not barred, from the slice.

Indicating to a UE 201 that it should consider a slice to be barred

When the RAN node receives an indication that a slice is barred, the RAN node will indicate to the UE 201 that the slice is barred.

The RAN node may transmit a sliceBarred indication in the System Information, e.g. MIB or SIB1. The sliceBarred indication will be received by UEs within range of the RAN node. The sliceBarred indication indicates to the UE 201 that one or more slices are barred in the RAN node. The MIB may also include an intraFreqReselection indication that indicates whether slice barring applies to cells on the same frequency.

When the UE 201 receives the sliceBarred indication, the UE 201 will initiate the process of determining whether one or more of the barred slices are slices that the UE 201 wants to attempt to access.

A new SIB may be defined to broadcast slice related barring information. The new SIB may be called SI-SliceInfo. SIB1 may broadcast scheduling information about the SI-SliceInfo.

If SIB1 indicates that the RAN node is not currently broadcasting SI-SliceInfo, the UE 201 may send an On-Demand-SI (On Demand System Information) request to the RAN node in order to request that the RAN node broadcast SI-SliceInfo. The On-Demand-SI (On Demand System Information) request may involve a RACH procedure that uses PRACH preamble(s) and PRACH resource(s) to indicate to the network that the UE 201 wants the network to broadcast SI-SliceInfo. Certain PRACH preamble(s) and PRACH resource(s) may be associated with particular S-NSSAI, SST, or SD values and the network may use this information to determine what information to include in the SI-SliceInfo broadcast. When the UE 201 receives an acknowledgment of the request, it will begin to receive SI-SliceInfo. The acknowledgment may indicate to the UE 201 that no slices are barred by the RAN node. Alternatively, SI-SliceInfo may be included in the Msg2 or Msg4.

SI-SliceInfo may include any combination of the following information elements. First, S-NSSAI(s) that are barred in the RAN Node. Second, SST value(s) that are barred in the RAN Node. If SST values are broadcasted, it may be an indication that S-NSSAIs with the SST value are barred. Third, SD value(s) that are barred in the RAN Node. If SD values are broadcasted, it may be an indication that S-NSSAIs with the SD value are barred. Fourth, a Barring Time that indicates how long the UE 201 should consider the corresponding S-NSSAI, SST, or SD value to be barred. A Barring Time may be provided for each S-NSSAI, SST, or SD value. Fifth, UE Identities, UE Group Identities, or UE Access Classes to which the barring information applies. When this information is present, the UE 201 may disregard the information if the UE's identity, the UE's group identity, or the UE's access class is not present. Sixth, a cause for the barring condition. For example, the cause may indicate to the UE 201 that the slice is barred because the slice has reached a limit in how many UEs are registered in the slice or the slice has reached a limit in how many PDU sessions are established within the slice. An intraFreqReselection indication that is used indicate whether or not the UE 201 should consider the S-NSSAI to be barred in cells on the same frequency. Seventh, information about what slices are available in the cell (S-NSSAIs, SSTs, or SDs). Eighth, information that might be used by the UE 201 to help the UE 201 to select a different cell that is not currently barring the slice.

It should be appreciated that the UE 201 may receive the SI-SliceInfo via a unicast message on the DL-SCH. This information may be sent to the UE 201 by the RAN node in a unsolicited manner (e.g. not in response to a UE 201 request), for example in the scenario where the RAN node is aware that the UE 201 is registered to a slice, determines that it is barred, and sends a unicast message to the UE 201 to indicate to the UE 201 that the slice is barred. Alternatively, the RAN node might unicast the SI-SliceInfo to the UE 201 in response to a request from the UE. The request from the UE 201 may have indicated that the UE 201 wants to check if any slices are barred and may indicate the slice names. The request from the UE 201 might be unrelated to barring and the RAN node might include the SI-SliceInfo in the response.

If the UE 201 is RM-DEREGISTERED and it determines that it should consider one or more slices are barred by a RAN node, the UE 201 may check whether any of the barred slices are in the UE's Configured NSSAI or in the Mapping Of Configured NSSAI that is associated with the PLMN. Then the UE 201 may choose to consider the RAN node to be lower in priority and go about checking other RAN nodes to see if it is possible to connect to a different RAN which does not consider slices that are in the UE's Configured NSSAI or Mapping Of Configured NSSAI to be barred. The other RAN nodes may be associated with other PLMNs, Alternatively, the UE 201 may choose to connect to the RAN by sending a Registration request to the network and not attempting to register with the barred S-NSSAI's. In other words, the UE 201 may send a Registration Request to the RAN Node and not include a barred S-NSSAI in the Requested NSSAI of the Registration Request. The UE 201 may periodically check System Information broadcast by the RAN node to see if the barred S-NSSAI is still barred. Checking the System Information broadcast by the RAN node to see if the barred S-NSSAI is still barred may be done as described herein. When the UE 201 sees that the S-NSSAI is no longer barred, the UE 201 may choose to send a Registration Request to the RAN Node with the formerly barred S-NSSAI in the Requested NSSAI.

If the UE 201 is RM-REGISTERED and it determines that it should consider one or more slices are barred by the RAN node, the UE 201 may check whether any of the barred S-NSSAI(s) are in the UE's Allowed NSSAI. If a barred S-NSSAI is in the UE's Allowed NSSAI, then the UE 201 may perform any combination of the following actions: First, when the UE 201 evaluates URSP rules, the UE 201 may consider any RSD that includes the S-NSSAI to be invalid while barred. Second, the UE 201 may deregister from the slice by sending a Registration Request to the network with a Request NSSAI that does not include the barred S-NSSAI(s). Third, the UE 201 may release any PDU Session that are associated with the barred S-NSSAI(s).

It should be noted that when the UE 201 determines whether it should consider one or more slices to be barred by the RAN node, it may need to consider what types, classes, or groups of UEs are barred from the slice and determine if the UE 201 is part of one or more of the types, classes, or groups of UEs that are barred. The UE 201 may only consider the slice barred if the UE 201 determines that it is part of one or more of the types, classes, or groups of UEs that are barred from the slice. As described herein, the UE 201 may use broadcasted information to determine what types, classes, or groups of UEs that are barred. The UE 201 may determine what types, classes, or groups the UE 201 belongs within the slice based on any combination of the following criteria. First, the UE 201 may be configured with the types, classes, or groups the UE 201 belongs within the slice via NAS signaling. Second, information in the UE's SIM card that was configured via SMS, NAS, or OMA DM signaling may indicate the types, classes, or groups the UE 201 belongs within the slice. For example, the SIM card may be programmed with slice specific class, group, or type information for the UE. For example, this information may indicate to the UE 201 that it is considered to be part of a low priority group within the slice. Third, the Configured NSSAI, or Mapping of Configured NSSAI, that was received by the UE 201 during registration (or pre-provisioned on the UE) may include class, group, or type information for each S-NSSAI within the Configured NSSAI. Fourth, the UE 201 may be configured with the types, classes, or groups the UE 201 belongs within the slice when the UE 201 establishes a PDU Session within the slice.

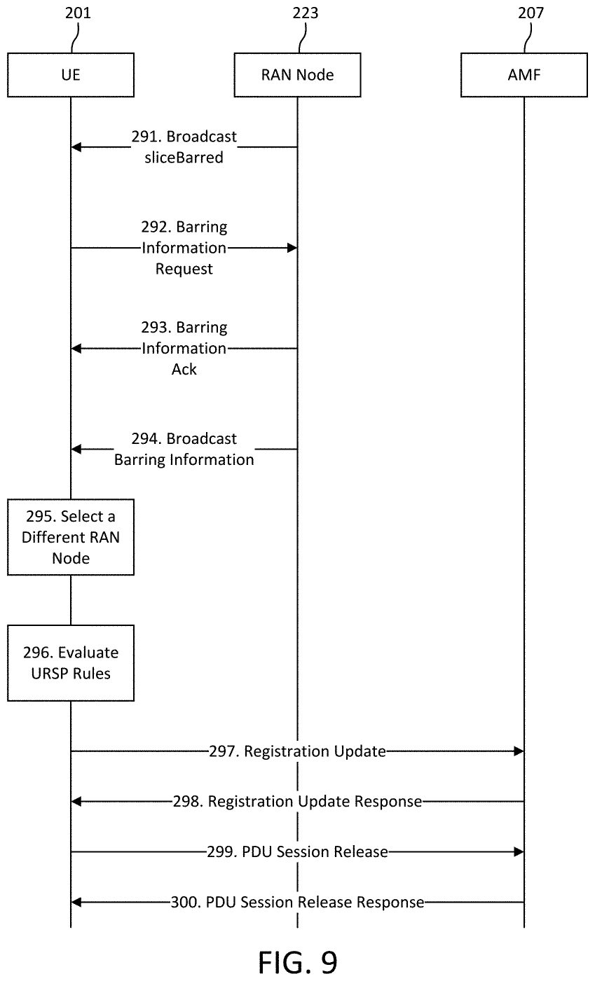

FIG. 9 illustrates an example of how the UE 201 may learn that a slice is barred and what actions that UE 201 might take after learning that a slice is barred.

In step 291 of FIG. 9, the RAN Node broadcasts an indication that one or more slices are considered barred by the RAN node. This is further described herein.

In step 292 of FIG. 9, the UE 201 requests more information from the RAN node in order to determine what slices (e.g. S-NSSAIs) are barred. This is further described herein.

In step 293 of FIG. 9, the RAN node acknowledges the UE's request for more information about what slices (e.g. S-NSSAIs) are barred. This is further described herein.

In step 294 of FIG. 9, the UE 201 receives more information about what slices (e.g. S-NSSAIs) are barred. For example, the information may be the S-NSSAI's, SSTs, SDs that are barred. The information may also include reasons, or causes, for the barring. This is further described herein.

In step 295 of FIG. 9, the UE 201 determines to select a different RAN node. The UE 201 would then restart at step 1 with a different RAN node. This is further described herein.

In step 296 of FIG. 9, after determining that a slice is barred, the UE 201 may consider any RSD that includes the S-NSSAI to be invalid while barred.

In step 297-step 298 of FIG. 9, if the UE 201 chose to continue connecting to the network via this RAN node, the UE 201 sends a Registration Update to the AMF. The Registration Update may not include any of the S-NSSAIs that were identified as barred in step 294. The AMF 207 will respond to the request and the barred S-NSSAIs will not be included in the allowed NSSAI that is provide to the UE. This is further described herein.

In step 299-step 300 of FIG. 9, if the UE 201 chose to continue connecting to the network via this RAN node, the UE 201 sends a PDU Session Release messages to the AMF 207 for any PDU Sessions that are associated with any of the S-NSSAIs that were identified as barred in step 294 and receives a release response. This is further described herein.

### Handling Registration Request for Barred Slices

When the UE 201 sends a NAS Registration Request to a RAN Node the Registration Request may be included in another RRC Message (e.g. an RRC Connection Establishment Request), the Requested NSSAI may be included in the AS signaling (e.g. RRC Connection Establishment Request). The RAN Node uses the Requested NSSAI in AMF Selection. The UE 201 may include an S-NSSAI in the Requested NSSAI that is barred. When the RAN Node detects that the UE 201 included an S-NSSAI in the Requested NSSAI that is barred, the RAN Node may take the following actions.

The RAN Node will not consider the barred S-NSSAI during AMF selection. Instead, it will proceed with AMF selection and only consider S-NSSAI's that are in the Requested NSSAI and that are not barred.

Once an AMF 207 is selected by the RAN Node, the RAN Node may send an N2 message to the AMF. The N2 message may include the Registration Request from the UE 201 and N2 Parameters. The N2 Parameters may include information that indicates that certain S-NSSAI's in the Requested NSSAI should be rejected by the AMF. The N2 Parameters may further indicate what types, groups, or classes of UEs are barred from the S-NSSAI. The information may further indicate a cause or reason for the rejection. For example, the information may indicate that S-NSSAI #1 should be rejected by the AMF 207 because it is barred by the RAN Node.

When the AMF 207 receives the N2 message and the N2 Parameters indicate a certain S-NSSAI(s) should be rejected, the AMF 207 will not consider allowing the indicated S-NSSAIs in the Requested NSSAI. The AMF 207 will include the indicated S-NSSAIs in the Rejected S-NSSAI in the Registration response that is sent to the UE 201. The AMF 207 may provide a cause code to the UE 201 to indicate why each S-NSSAI was rejected. The cause code may be determined by the AMF 207 based on the cause code that was provided by the RAN Node in the N2 Parameters. The determined cause code may indicate to the UE 201 that the S-NSSAI is barred. If the AMF 207 determines that no S-NSSAI can be provided in the Allowed NSSAI, the AMF 207 will reject the Registration Request.

If the N2 Parameters indicated that only certain types, groups, or classes of UEs are barred from the S-NSSAI (or are not barred), then the AMF 207 may check the UE's subscription, or context information, to determine if barring applies to the UE 201 and if the S-NSSAI should be included in the UE's Allowed NSSAI.

### Improving the Efficiency of the Existing Unified Access Control Mechanism

As described herein, the Network Operator may need to keep track of what Access Category Definitions have been sent to the UE 201. Furthermore, the UE 201 may, based on implementation, delete the Access Category Definitions that are associated with a PLMN (e.g. due to a reset of the device or because the UE 201 did not attach to the PLMN for a long time).

Interaction between the UE 201 and the Network can be made to be more efficient if the Operator-defined access category definitions Information Element that is sent to the UE 201 during registration, or during a configuration update, were updated to include a unique identifier that identifies the set of definitions that are carried in the IE. Each time the UE 201 registers with the network, the UE 201 may provide this identifier in the Registration Request message as a way of indicating to the network that the UE 201 still has the Operator-defined access category definitions stored for the PLMN.

As per the Release 15 NR specification, slice specific access control can be somewhat done through the appropriate operator defined slice specific access category configuration and access baring parameters configuration. However, as a UE 201 roams around, the meaning of operator defined access category might change from one geographical area to another leading to a miss match between the expected level of service or access privilege and the service level or access privilege level provided by the network. Furthermore, as 5G systems are being designed to support requirements (such as security and privacy requirements) from different vertical domain of industries or applications, it will likely be desirable in some cases to have well defined default behaviors in terms of slice provisioning across operators' networks and across devices when accessing the network or in terms of quality of service expectation once connected to the network. For example, taking the case of eHealth use cases, certain applications may require plug and play from one network to the other wherein the allowed network slice(s) are preconfigured into the UE 201 for the purpose of access control and traffic isolation. It should be noted such devices might be reduced capability devices with build-in preconfigured service capabilities. It is therefore proposed to have rules captures in 3GPP specification, that specifies mapping between a slices and access category or access category number for certain pre-defined or specified slice, wherein the access category number is a unique identifier assigned to an access category. The UE 201 uses such mapping to identify an access category, to be used to perform access control and access baring check when initiating an access to a network slice pertaining to one of the specified rules. Example of specified rules for UE 201 to determine an access category for an access attempt pertaining to a specific slice is shown in Table 6. It should be appreciated that these rules may be provisioned into the UE 201 by the network via NAS signaling. These rules may also be provisioned into the by the network via Over-The-Air Device Management (OTA-DM) signaling. They may also be preconfigured into the UE 201 or be configured into the UE 201 via RRC signaling.

TABLE 6
Rules to Determine an Access Category for an Access Attempt Pertaining to a Specific Slice

| | | Type of access | | Access |
|---|---|---|---|---|
| Rul e# | Slice ID | attempt | Requirements to be met | Category |
| 1 | NSSAI 1 or | Response to paging or | Access attempt is for MT | 8 |
| | S-NSSAI 1 or | NOTIFICATION over | access, or handover of | |
| | SST 1 or SD 1 | non-3GPP access; | ongoing MMTEL voice call, | |
| | | 5GMM connection | MMTEL video call or SMSoIP | |
| | | management procedure | from non-3GPP access | |
| | | initiated for the | | |
| | | purpose of | | |
| | | transporting an LPP | | |
| | | message without an | | |
| | | ongoing 5GC-M0-LR | | |
| | | procedure; | | |
| | | Access attempt to | | |
| | | handover of ongoing | | |
| | | MMTEL voice call, | | |
| | | MMTEL video call or | | |
| | | SMSoIP from non-3GPP | | |
| | | access | | |
| 2 | NSSAI 2 or | Emergency | UE is attempting access | 10 |
| | S-NSSAI 2 or | | for an emergency session | |
| | SST 2 or SD2 | | | |
| 3 | NSSAI 3 or | Access attempt for | (a) UE is configured for | 11 |
| | S-NSSAI 3 or | delay tolerant | NAS signalling low priority | |
| | SST 3 or SD 3 | service | or UE supporting S1 mode is | |
| | | | configured for EAB (see the | |
| | | | “ExtendedAccessBarring” leaf | |
| | | | of NAS configuration MO in | |
| | | | 3GPP TS 24.368 V15.1.0 [10] | |
| | | | or 3GPP TS 31.102 V15.7.0 | |
| | | | [11]) where “EAB override” | |
| | | | does not apply, and | |
| | | | (b): the UE received one of | |
| | | | the categories a, b or c as | |
| | | | part of the parameters for | |
| | | | unified access control in | |
| | | | the broadcast system | |
| | | | information, and the UE is | |
| | | | a member of the broadcasted | |
| | | | category in the selected PLMN | |
| | | | or RPLMN/equivalent PLMN | |
| 4 | NSSAI 4 or | MO IMS | Access attempt is for MO IMS | 11 |
| | S-NSSAI 4 or | registration related | registration related signalling | |
| | SST 4 or SD4 | signalling | (e.g. IMS initial registration, | |
| | | | re-registration, subscription | |
| | | | refresh) | |
| | | | or for NAS signalling | |
| | | | connection recovery during | |
| | | | ongoing procedure for MO | |
| | | | IMS registration related | |
| | | | signalling | |
| 5 | NSSAI 5 or | MO MMTel voice | Access attempt is for MO | 12 |
| | S-NSSAI 5 or | call | MMTel voice call | |
| | SST 5 or SD 5 | | or for NAS signalling | |
| | | | connection recovery during | |
| | | | ongoing MO MMTel voice call | |
| 6 | NSSAI 6 or | MO MMTel video | Access attempt is for MO | 13 |
| | S-NSSAI 6 or | call | MMTel video call | |
| | SST 6 or SD 6 | | or for NAS signalling | |
| | | | connection recovery during | |
| | | | ongoing MO MMTel video call | |
| 7 | NSSAI 7 or | MO SMS over | Access attempt is for MO SMS | 14 |
| | S-NSSAI 7 or | NAS or MO | over NAS or MO SMS over | |
| | SST 7 or SD 7 | SMSoIP | SMSoIP transfer | |
| | | | or for NAS signalling | |
| | | | connection recovery during | |
| | | | ongoing MO SMS or SMSoIP | |
| | | | transfer | |
| 8 | NSSAI 8 or | UE NAS initiated | Access attempt is for MO | 15 |
| | S-NSSAI 8 or | 5GMM specific | signalling | |
| | SST 8 or SD 8 | procedures | | |
| 9 | NSSAI 9 or | Mobile originated | Access attempt is for mobile | 16 |
| | S-NSSAI 9 or | location request | originated location request | |
| | SST 9 or SD 9 | | | |
| 10 | NSSAI 10 or | Mobile originated | Access attempt is for mobile | 17 |
| | S-NSSAI 10 or | signalling | originated signalling | |
| | SST 10 or SD 10 | transaction | transaction towards the PCF | |
| | | towards the PCF | | |
| 11 | NSSAI 11 or | UE NAS initiated | Access attempt is for MO data | 18 |
| | S-NSSAI 11 or | 5GMM connection | | |
| | SST 11 or SD 11 | management | | |
| | | procedure or | | |
| | | 5GMM NAS | | |
| | | transport | | |
| | | procedure | | |
| 12 | NSSAI 12 or | An uplink user | No further requirement is to be | 19 |
| | S-NSSAI 12 or | data packet is to be | met | |
| | SST 12 or SD 12 | sent for a PDU | | |
| | | session with | | |
| | | suspended user- | | |
| | | plane resources | | |
| 13 | NSSAI 13 or | UE NAS initiated | Access attempt is for MO | 20 |
| | S-NSSAI 13 or | 5GMM connection | Exception data | |
| | SST 13 or SD 13 | management | | |
| | | procedure or | | |
| | | 5GMM NAS | | |
| | | transport | | |
| | | procedure | | |

### 1.1.1 Slice-Based Random Access

Random access resources (e.g. RACH preambles, RACH transmission resources in time and frequency domain) may be (pre)configured or reserved by specification with mapping into specific network slice or group of slices. In other words, the random access resources may be partitioned and (pre)configured into the UE 201 on network slice basis. During the random access procedure, the UE 201 may indicate to the network, the requested slice or group of slices by using a random-access resource that maps to the desired or intended or requested network slice or group slice. Such feature might be beneficial for example in support of random access prioritization in the network or in support of congestion control by the network. The UE 201 might also use this mechanism to request from the network, slice specific resource grants for uplink data transmission, particularly for use cases such as Early Data Transmission or small data transmission where the UE 201 might request a grant to transmit small size data without a full transition into RRC connected state.

### Service-Based Partitioning of RACH Resources

RACH resources may be grouped or partitioned into several groups or partitions, each group or partition may be associated with one service type or slice(s). For example, one RACH resource group or partition may be associated with eMBB service type or slice(s), another RACH resource group or partition may be associated with another service type or slice(s), e.g., mMTC, while yet another RACH resource group or partition may be associated with yet another service type or slice(s), e.g., URLLC. The network may allocate resources for the different types based on the expected initial access traffic for a given type.

When UE 201 perform initial access or random access, UE 201 may use RACH resource group to implicitly indicate to gNB and network which service type or slice(s) it desires.

In addition, different RO groups or partitions may be associated with different payload sizes, TBSs or grant sizes. For example, when UE 201 transmit PRACH on one RO group or partition, the UE 201 is requesting or indicating a large payload, TBS or grant, another RO group or partition may request another payload size, TBS or grant size e.g., medium payload, TBS or grant size while the third RO group or partition may request a small payload, TBS, or grant size.

Depending on the payload, TBS and grant granularity, RO may be grouped or partitioned into multiple e.g., more than three groups or partitions to indicate different service types or slices.

Yet another consideration, different RO groups or partitions may be associated with priority. UE 201 may use different RO groups or partitions to indicate different priorities or the like.

### Slice-Based Prioritized Random Access

Slice type-based RACH configurations may be used. For example, one slice type may have higher initial transmit preamble power than the other slice type. This may enable higher priority slice type may succeed better for random access than lower priority slice type, and vice versa. Another example is that higher priority slice type may use much larger power ramping step size than lower priority slice type. On the other hand, lower priority slice type may use much smaller power ramping step size than higher priority slice type. Yet another approach may be to use smaller random backoff counter or window for high priority slice type than low priority slice type, and vice versa. Other similar approaches, extension or the like may also be considered and used.

### Slice-Based Paging

A slice-based paging mechanism may be defined wherein, the UE 201 behavior in terms of paging monitoring, UE 201 addressing for paging message notification or paging message content is specific to slice or group of slices the UE 201 is interested in. A UE 201 may be configured with multiple applications, each of which may be mapped to different network slice configurations and requirements. Depending on factors such as the application the UE 201 is interested in during any given period of time and the UE subscription profile, the UE 201 may autonomously select, or configured by the network (for example a core network function or node such as the AMF, or base station function or node such as gNB) or select in coordination with the network, a slice or a group of slices for paging monitoring and reception purposes. Such slice or set of slices may be a subset of the slices the UE 201 may use or is allowed to use in the current serving cell for e.g. the cell the UE 201 is currently camped on.

Slice-based paging configuration: In support of slice-based paging mechanism, the UE 201 may be configured with paging configuration parameters specific to a network slice or to a set of network slices. Slice specific paging configuration parameters may include one or more of the following parameters: Slice specific T, Slice specific N, Slice specific N_{S}, Slice specific PF, Slice specific UE_ID, Slice specific UE specific DRX value(s), Slice specific Default DRX value, or Slice specific first-PDCCH-MonitoringOccasionOfPO.
Slice specific T: Slice specific DRX cycle of the UE 201 (T is determined by the shortest of UE specific DRX value(s), if configured by RRC or upper layers, slice specific UE specific DRX value(s) if configured by RRC or upper layers, default DRX value broadcast in system information, and a slice specific default DRX value broadcast in system information. In RRC_IDLE state, if UE specific DRX is not configured by upper layers, the default value is applied, similarly if slice specific UE specific DRX is not configured by upper layers, the slice specific default value is applied).
Slice specific N: slice specific number of total paging frames in slice specific T
Slice specific N_{S}: slice specific number of paging occasions for a slice specific PF
Slice specific PF_offset: slice specific offset used for slice specific PF determination
Slice specific UE_ID: slice specific 5G-S-TMSI mod 1024
Slice specific UE specific DRX value(s)
Slice specific Default DRX value
Slice specific first-PDCCH-MonitoringOccasionOfPO

Slice-Based Paging Monitoring, UE Addressing for Paging and Paging Content

The UE 201 may use one or more of the slice-based paging configuration parameters configured into the UE 201 for the calculation of slice specific Paging Frame (PF) and slice specific index i_s of the Paging Occasion (PO). PO may be slice specific, and how many consecutive PDCCH monitoring occasions constitute a PO may be configured into the UE 201 on slice basis. The parameter SeachSpaceId (as defined in 38.304) configured into the UE 201 for pagingSearchSpace or the pagingSearchSpace may be slice specific.

The Radio Network Temporary Identifier (RNTI) used by the UE 201 to identify, and differentiate paging message from other messages received from the network, for example the P-RNTI may be specific to a slice or group of slice. A slice specific RNTI such as P-RNTI may be used by the network to address paging messages to a UE. A UE 201 may use slice specific P-RNTI to monitor, identify or differentiate paging messages intended for a specific network slice. A paging message may also include one or more slice identifiers. A UE 201 may use such a slice identifier to identify or differentiate paging messages intended for a specific network slice.

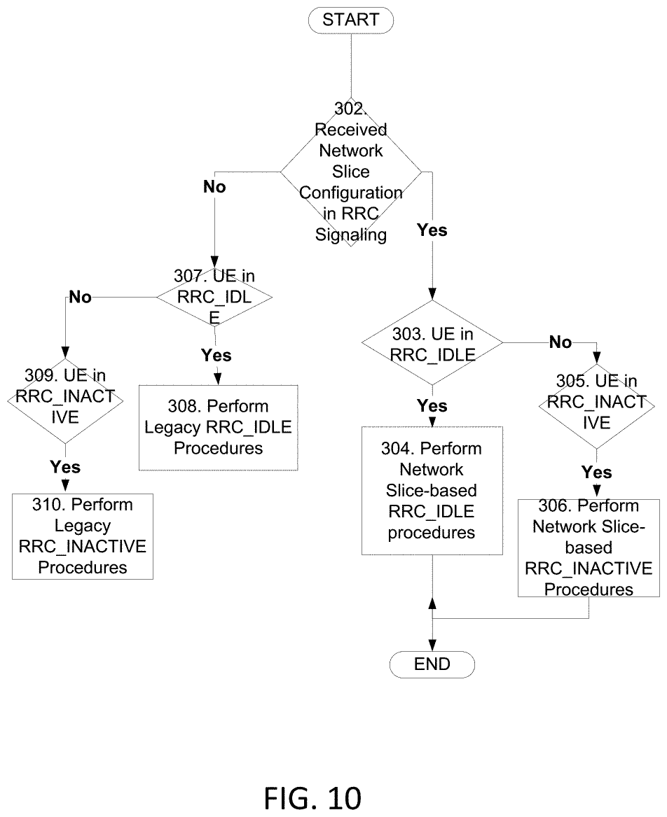

FIG. 10 illustrates an exemplary method flow associated with the RAN slicing subject matter disclosed herein. At step 302, there is a determination of whether network slice configuration was received (e.g., via RRC signaling). If received, then at step 303 there is a determination whether the UE is in RRC_IDLE. If in RRC_IDLE, then at step 304 network slice-based RRC_IDLE procedures are performed. If at step 303 the UE is not in RRC_IDLE then at step 305 there is a determination if the UE is in RRC_INACTIVE. If the UE is in RRC_INACTIVE then at step 306 network slice-based RRC_INACTIVE procedures are performed.

With continued to FIG. 10, if network slice configuration is not received, then at step 307 there is a determination if the UE is in RRC_IDLE. If the UE is in RRC_IDLE, then at step 308 legacy RRC_IDLE procedures are performed. With reference to step 307, if UE is not in RRC_IDLE, then at step 309 there is a determination of whether the UE is RRC_INACTIVE. If the UE is in RRC_INACTIVE then legacy RRC_INACTIVE procedures are performed.

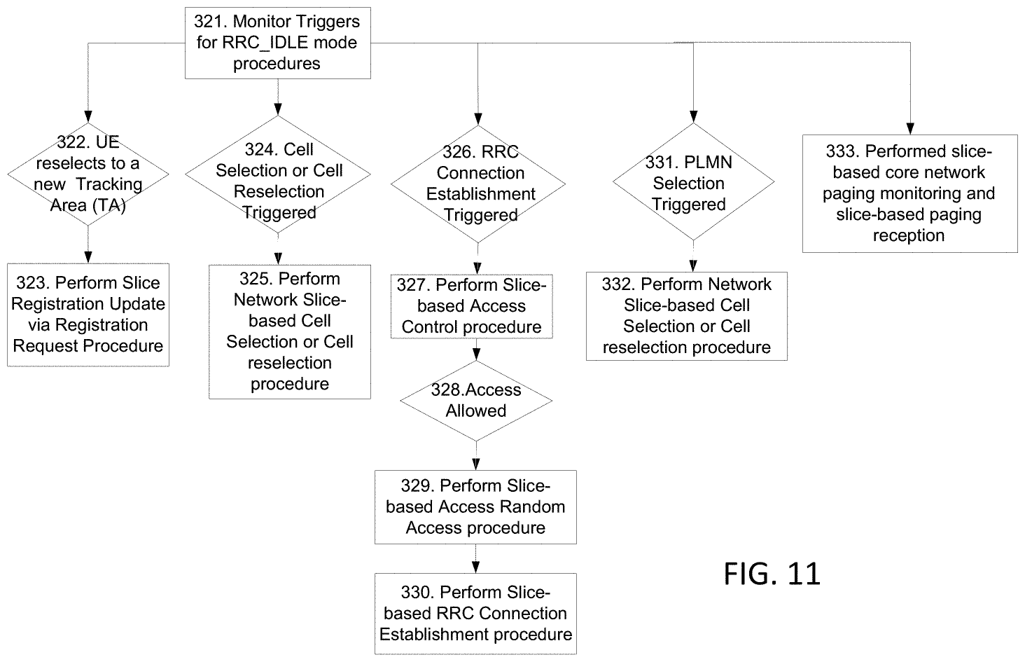

FIG. 11 illustrates an exemplary method flow associated with RAN slicing. At step 321, a device may monitor triggers for RRC_IDLE mode procedures. Based on a network slice configuration and a trigger any of step 322 (UE reselects to a new tracking area), step 324 (cell selection or cell reselection triggered), step 326 (RRC connection establishment triggered), step 331 (PLMN selection triggered), or step 333 (perform slice-based core network paging monitoring and slice-based paging reception) may be the triggered. Respectively, once triggered, there may be procedures performed, such as step 323 (perform slice registration update via registration request procedure), step 325 (perform network slice-based cell selection or reselection procedure), step 327 (perform slice based access control procedure), or step 332 (perform network slice-based cell selection or reselection procedure). Following step 327, if access is allowed at step 328, then perform slice-based access random access procedure at step 329, and then perform slice-based RRC connection establishment procedure for step 330.

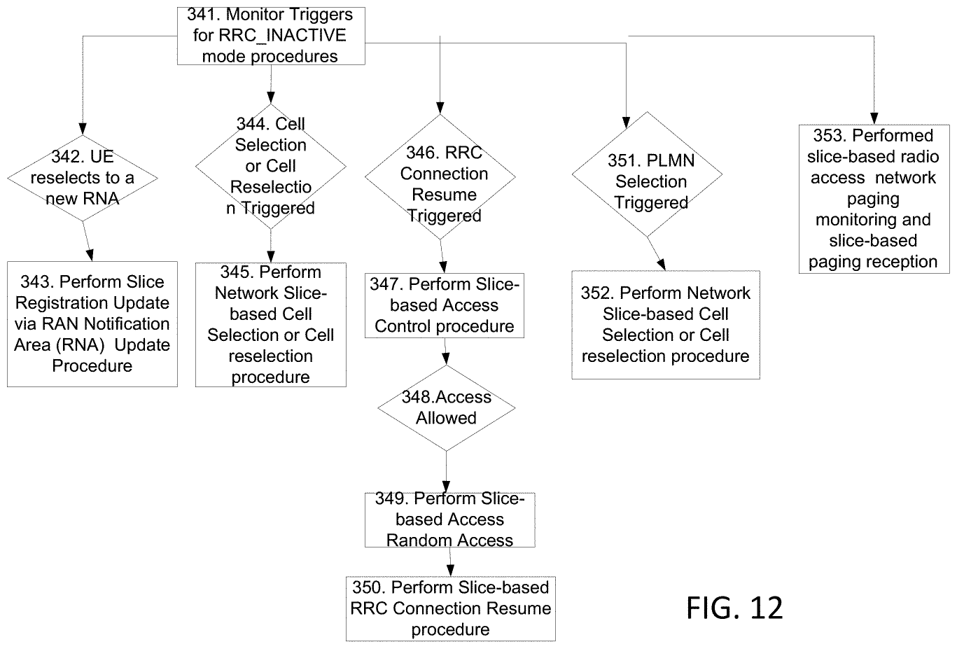

FIG. 12 illustrates an exemplary method flow associated with RAN slicing. At step 341, triggers for RRC_INACTIVE mode procedures may be monitored. Based on a network slice configuration and a trigger any of step 342 (UE reselects to a new RNA), step 344 (cell selection or reselection triggered), step 346 (RRC connection resume triggered), step 351 (PLMN selection triggered), or step 353 (performed slice-based radio access network paging monitoring and slice based paging reception). Respectively, once triggered, there may be procedures performed, such as step 343 (Slice Registration Update via RAN Notification Area (RNA) Update Procedure), step 345 (Perform Network Slice-based Cell Selection or Cell reselection procedure), step 347 (Perform Slice-based Access Control procedure), or step 352 (Perform Network Slice-based Cell Selection or Cell reselection procedure). Following step 347, if access is allowed at step 348, then perform slice-based access random access procedure at step 349, and then perform slice-based RRC connection resume procedure for step 350.

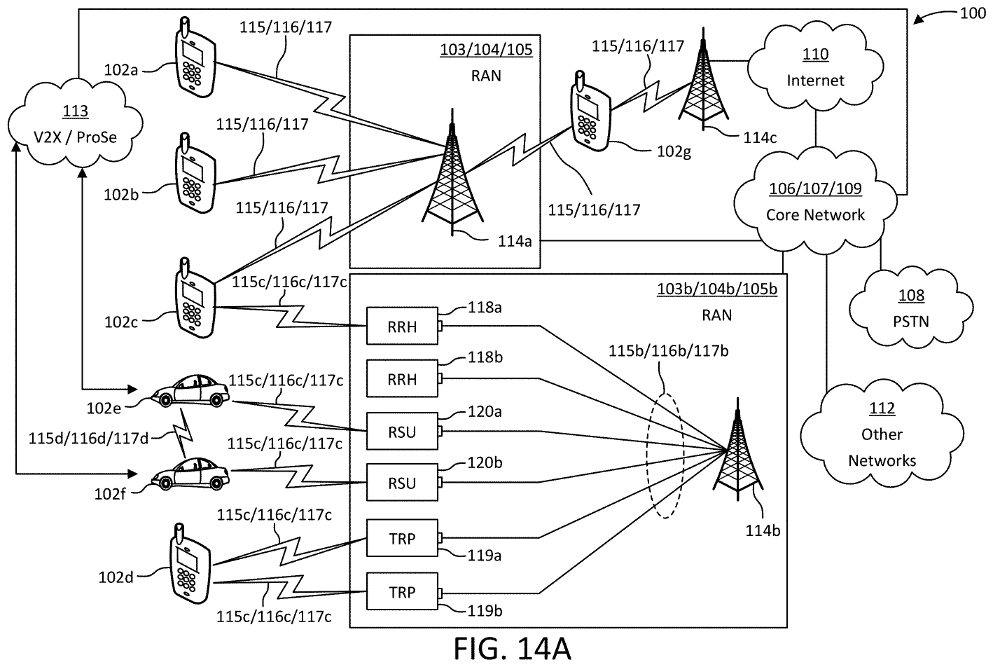

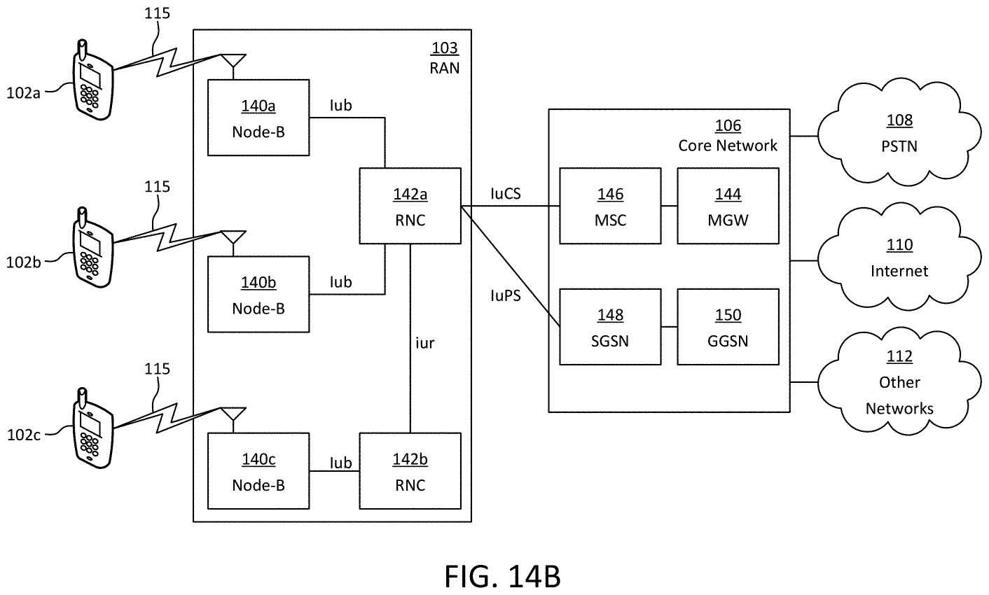

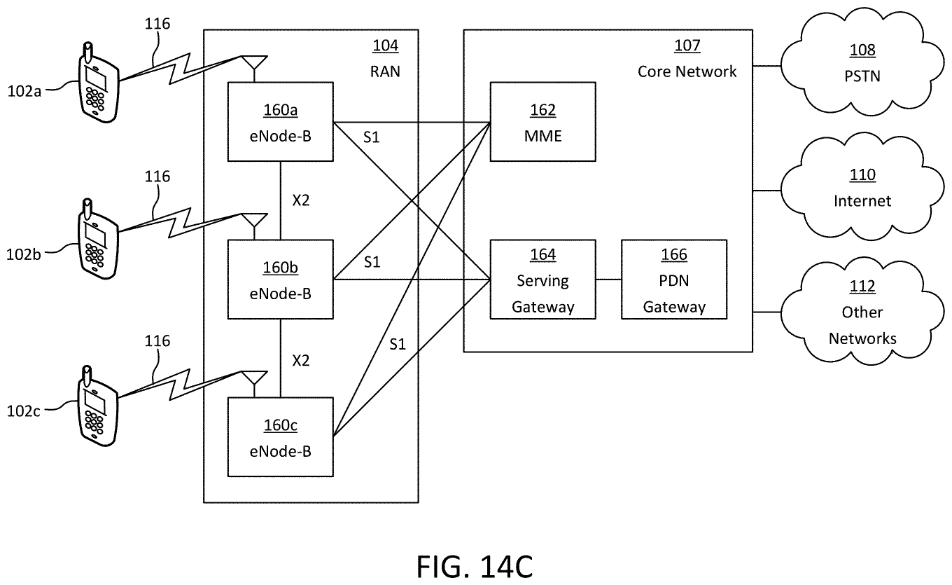

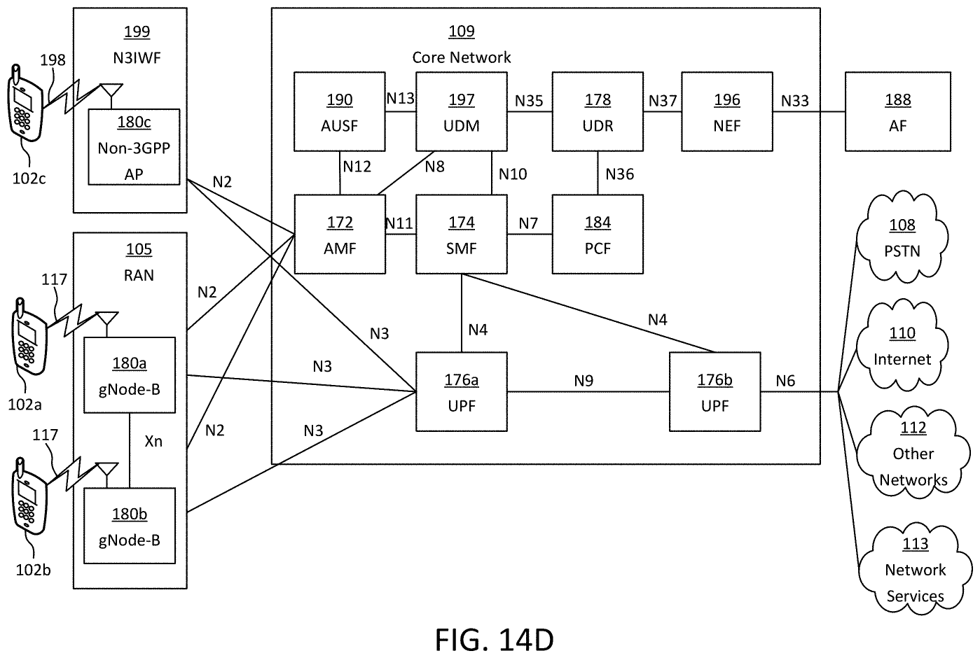

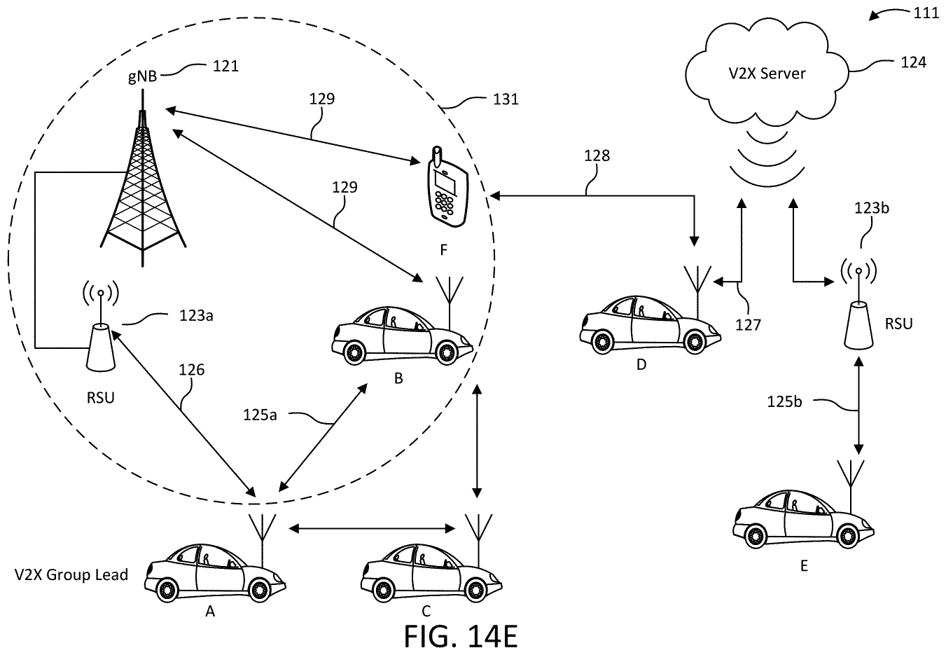

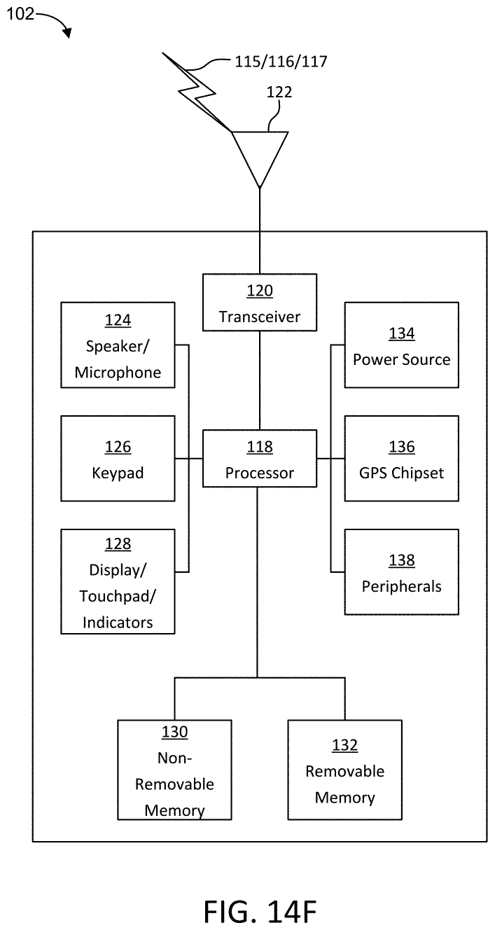

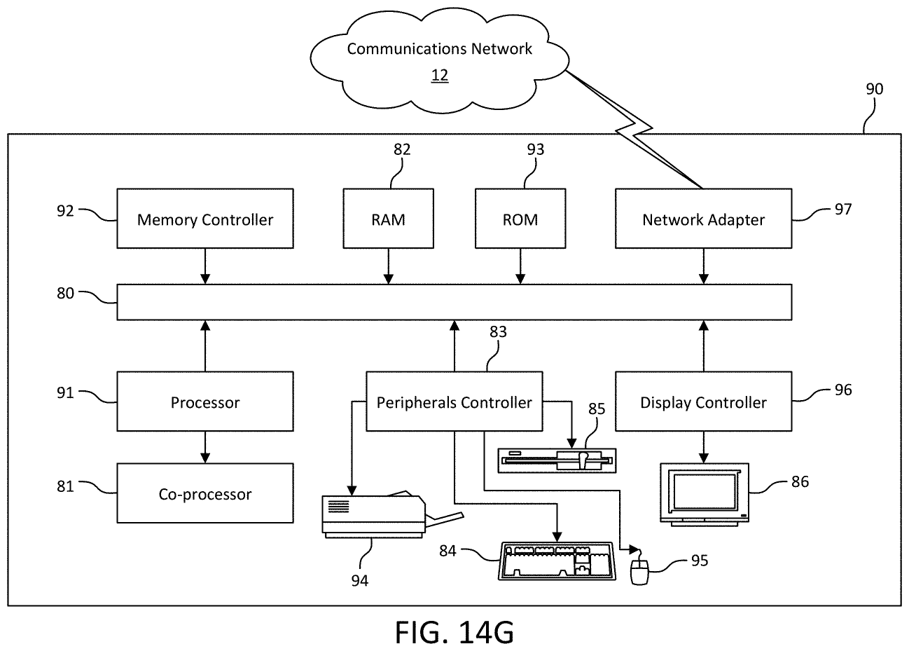

It is understood that the entities performing the steps illustrated herein, such as FIG. 1-FIG. 9, may be logical entities. The steps may be stored in a memory of, and executing on a processor of, a device, server, or computer system such as those illustrated in FIG. 14A-FIG. 14G. Skipping steps, combining steps, or adding steps between exemplary methods disclosed herein (e.g., FIG. 1-FIG. 9) is contemplated. Table 7 discloses abbreviations that may be used herein.

TABLE 7
Abbreviations and Definitions

| Abbreviations | Definitions |
|---|---|
| 5G | Fifth Generation |
| 5GC | 5G Core Network |
| 5GS | 5G System |
| AMF | Access and Mobility Management Function |
| AS | Access Stratum |
| CD-SSB | Cell Defining SSB |
| CM | Connection Management |
| CMAS | Commercial Mobile Alert System |
| CN | Core Network |
| CRS-NSSAI | Cell Reselection Network Slice |
| | Selection Assistance Information |
| DNN | Data Network Name |
| eMBB | Enhanced Mobile Broadband |
| ETWS | Earthquake and Tsunami Warning System |
| gNB | NR NodeB |
| IoT | Internet of Things |
| LCG | Logical Channel Group |
| LCH | Logical Channel |
| MAC | Medium Access Control |
| MioT | Massive IOT |
| MNO | Mobile Network Operator |
| MO | Mobile Originated |
| MT | Mobile Terminated |
| N3IWF | Non-3GPP InterWorking Functions |
| NAS | Non-Access Stratum |
| NCL | Neighbor Cell List |
| NG-RAN | Next Generation Radio Access Network |
| NR | New Radio |
| NSSAI | Network Slice Selection Assistance Information |
| OAM | Operations Administration and Maintenance |
| PCI | Physical Cell ID |
| PDCP | Packet Data Convergence Protocol |
| PDU | Protocol Data Unit |
| PF | Paging Frame |
| PLMN | Public Land Mobile Network |
| PO | Paging Occasion |
| PRACH | Physical Random Access Channel |
| P-RNTI | Paging Radio Network Temporary Identifier |
| QoS | Quality of Service |
| RLC | Radio Link Control |
| SDAP | Service Data Adaptation Protocol |
| RA | Registration Area |
| RACH | Random Access Channel |
| RAN | Radio Access Network |
| RAT | Radio Access Technology |
| REDCAP | Reduced Capability |
| RM | Registration Management |
| RNA | RAN Notification Area |
| RNTI | Radio Network Temporary Identifier |
| RRC | Radio Resource Control |
| RRM | Radio Resource Management |
| RSRP | Reference Signal Received Power |
| RSRQ | Reference Signal Received Quality |
| SD | Slice Differentiator |
| SI | System Information |
| SLA | Service Level Agreement |
| S-NSSAI | Single-Network Slice Selection Assistance Information |
| SSB | Synchronization Signal/PBCH Block |
| SMF | Session Management Function |
| SST | Slice/Service Type |
| TA | Tracking Area |
| TDD | Time Division Duplex |
| UE | User Equipment |
| UPF | User Plane Function |
| URLLC | Ultra-Reliable Low-Latency Communication |
| V2X | Vehicle-to-Everything |
| VPLMN | Visited Public Land Mobile Network |

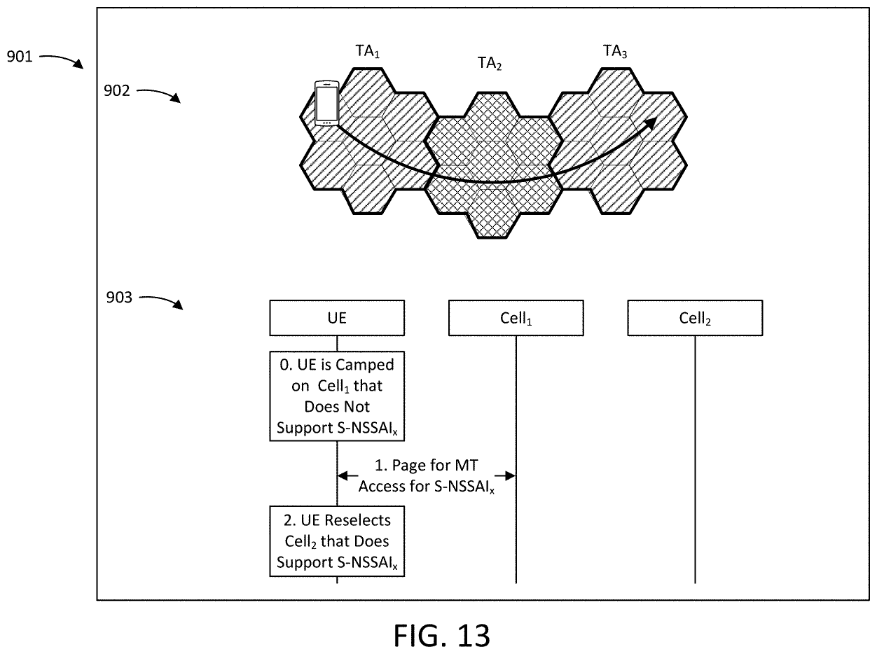

FIG. 13 illustrates an exemplary display (e.g., graphical user interface) that may be generated based on the methods, systems, and devices of RAN slicing, as discussed herein. Display interface 901 (e.g., touch screen display) may provide text in block 902 associated with RAN slicing. Progress of any of the steps (e.g., sent messages or success of steps) discussed herein may be displayed in block 902. In addition, graphical output 902 may be displayed on display interface 901. Graphical output 903 may be the topology of the devices implementing the methods, systems, and devices of RAN slicing, a graphical output of the progress of any method or systems discussed herein, or the like.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to include a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. These use cases and others are contemplated herein.

FIG. 14A illustrates an example communications system 100 in which the methods and apparatuses of mobility signaling load reduction, such as the systems and methods illustrated in FIG. 1 through FIG. 9 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 14A, FIG. 14B, FIG. 14C, FIG. 14D, FIG. 14E, or FIG. 14F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 14A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of RAN slicing, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPS 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 14A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of RAN slicing, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 14A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 14A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of RAN slicing, as disclosed herein. For example, the WTRU 102g shown in FIG. 14A may be configured to communicate with the base station 114a, which may employ a cellular-based radio technology, and with the base station 114c, which may employ an IEEE 802 radio technology.

Although not shown in FIG. 14A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 14B is a system diagram of an example RAN 103 and core network 106 that may implement methods, systems, and devices of RAN slicing, as disclosed herein. As noted herein, the RAN 103 may employ a UTRA radio technology to communicate with the WTRUs 102a, 102b, and 102c over the air interface 115. The RAN 103 may also be in communication with the core network 106. As shown in FIG. 14B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 14B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 14B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 14C is a system diagram of an example RAN 104 and core network 107 that may implement methods, systems, and devices of RAN slicing, as disclosed herein. As noted herein, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 14C, the eNode-Bs 160a, 160b, and 160c may communicate with one another over an X2 interface.

The core network 107 shown in FIG. 14C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 14D is a system diagram of an example RAN 105 and core network 109 that may implement methods, systems, and devices of RAN slicing, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 14D, the gNode-Bs 180a and 180b may communicate with one another over an Xn interface, for example.

The core network 109 shown in FIG. 14D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 14G.

In the example of FIG. 14D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not include all of these elements, may include additional elements, and may include multiple instances of each of these elements. FIG. 14D shows that network functions directly connect with one another, however, it should be appreciated that they may communicate via routing agents such as a diameter routing agent or message buses.

In the example of FIG. 14D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 14D. The SMF 174 may be connected to the AMF 172 via an N11 interface.

Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 14D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 14D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 14A, FIG. 14C, FIG. 14D, or FIG. 14E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 14A, FIG. 14B, FIG. 14C, FIG. 14D, or FIG. 14E are provided by way of example only, and it is understood that the subject matter disclosed and claimed herein may be embodied or implemented in any similar communication system, whether presently defined or defined in the future.

FIG. 14E illustrates an example communications system 111 in which the systems, methods, apparatuses that implement RAN slicing, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 14E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 14E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE 201 via a Vehicle-to-Person (V2P) interface 128.

FIG. 14F is a block diagram of an example apparatus or device WTRU 102 that may be configured for wireless communications and operations in accordance with the systems, methods, and apparatuses that implement RAN slicing, described herein, such as a WTRU 102 of FIG. 14A, FIG. 14B, FIG. 14C, FIG. 14D, or FIG. 14E, or FIG. 1-FIG. 9 (e.g., UEs or Cells). As shown in FIG. 14F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 14F and may be an exemplary implementation that performs the disclosed systems and methods for RAN slicing described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, or any other functionality that enables the WTRU 102 to operate in a wireless environment. The processor 118 may be coupled to the transceiver 120, which may be coupled to the transmit/receive element 122. While FIG. 14F depicts the processor 118 and the transceiver 120 as separate components, it will be appreciated that the processor 118 and the transceiver 120 may be integrated together in an electronic package or chip.

The transmit/receive element 122 of a UE 201 may be configured to transmit signals to, or receive signals from, a base station (e.g., the base station 114a of FIG. 14A) over the air interface 115/116/117 or another UE 201 over the air interface 115d/116d/117d. For example, the transmit/receive element 122 may be an antenna configured to transmit or receive RF signals. The transmit/receive element 122 may be an emitter/detector configured to transmit or receive IR, UV, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 14F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted herein, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, or the display/touchpad/indicators 128 (e.g., a liquid crystal display (LCD) display unit or organic light-emitting diode (OLED) display unit. The processor 118 may also output user data to the speaker/microphone 124, the keypad 126, or the display/touchpad/indicators 128. In addition, the processor 118 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown). The processor 118 may be configured to control lighting patterns, images, or colors on the display or indicators 128 in response to whether the setup of the systems in some of the examples described herein are successful or unsuccessful, or otherwise indicate a status of RAN slicing and associated components. The control lighting patterns, images, or colors on the display or indicators 128 may be reflective of the status of any of the method flows or components in the FIG.'S illustrated or discussed herein (e.g., FIG. 1-FIG. 9, etc.). Disclosed herein are messages and procedures of RAN slicing. The messages and procedures may be extended to provide interface/API for users to request resources via an input source (e.g., speaker/microphone 124, keypad 126, or display/touchpad/indicators 128) and request, configure, or query RAN slicing related information, among other things that may be displayed on display 128.

The processor 118 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 14G is a block diagram of an exemplary computing system 90 in which one or more apparatuses of the communications networks illustrated in FIG. 14A, FIG. 14C, FIG. 14D and FIG. 14E as well as RAN slicing, such as the systems and methods illustrated in FIG. 1 through FIG. 9 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for RAN slicing, such as receiving certain messages.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 14A, FIG. 14B, FIG. 14C, FIG. 14D, or FIG. 14E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—RAN slicing—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may include the steps of UE is camped on a cell in TA₂; the UE reselects a cell in TA₁; the UE performs a Mobility Registration Update procedure to inform the network that it has moved to a TA that supports a different set of RAN slices; an AMF invokes the SMF's UpdateSMContext service to inform the SMF that the UE is not able to transmit/receive data for PDU sessions associated with slices that are not available; and AMF sends a Registration Accept message to the UE and indicates to the UE that PDU Sessions that are associated with the S-NSSAI that is not available are suspended or terminated. The Registration Accept may also include a timer that indicates that the PDU Session should be considered terminated if the UE does not Re-Register with the network in a location where the S-NSSAI is allowed before the timer has expired. All combinations in this paragraph and the following paragraphs (including the removal or addition of steps) are contemplated in a manner that is consistent with the other portions of the detailed description

Methods, systems, and apparatuses, among other things, as described herein may include the steps of the UE reselects a cell in TA₂; the UE performs a Mobility Registration Update procedure to inform the network that it has moved to a TA that supports a different set of RAN slices; the AMF invokes the SMF's UpdateSMContext service to inform the SMF/UPF that the UE is able to transmit/receive data for PDU sessions associated with slices that are available; the AMF sends a Registration Accept message to the UE and indicates to the UE that PDU Sessions that are associated with the S-NSSAI that are no longer suspended; the UE commences with UL/DL data transmission and reception for PDU sessions associated with S-NSSAI_{y}, where the DL data may include any data that was buffered by the SMF/UPF while the UE was in TA₁. UL/DL data transmission and reception for PDU sessions associated with other S-NSSAIs supported in TA₂. All combinations in this paragraph and below paragraphs (including the removal or addition of steps) are contemplated in a manner that is consistent with the other portions of the detailed description.

Methods, systems, and apparatuses, among other things, as described herein may include the steps of camping, by a user equipment (UE), on a cell in first tracking area or a first radio access network notification area; reselecting, by the user equipment, a cell in a second tracking area or a second radio access network notification area; performing a mobility registration update procedure or UE configuration update command, wherein the mobility registration update procedure or UE configuration update command indicates that the second tracking area or the second radio access network notification area supports a different set of radio access network (RAN) slices than the first tracking area; determining S-NSAAI status with reference to suspension based on a received message; and in response to the message, commencing with uplink data or downlink data transmission or reception for PDU sessions associated with the S-NSSAI. The second tracking area may not support S-NSSAI. The downlink data may include data that was buffered by a session management function or user plane function while the user equipment was in the second tracking area. All combinations in this paragraph and below paragraph (including the removal or addition of steps) are contemplated in a manner that is consistent with the other portions of the detailed description.

Methods, systems, and apparatuses, among other things, as described herein may include the steps of receiving, from a second apparatus, information including a network slice configuration, wherein the network slice configuration comprises network slice selection assistance information (NSSAI), single-NSSAI (S-NSSAI), slice/service type (SST), or slice differentiator (SD); and based on the network slice configuration, performing, by a first apparatus, the following: cell selection; cell reselection; slice area registration update; radio resource control (RRC) connection establishment; RRC resume; public land mobile network (PLMN) selection; access control; random access; or paging reception. The NSSAI, the S-NSSAI, the SST, or the SD may be configured into the first apparatus as available or not available per cell, per physical cell identifier, per TA, per radio access network notification area, or per frequency. The cell selection or cell reselections may use slice priority (e.g., a preferred slice). The slice area registration update may be based on mobility registration update or RAN Notification Area (RNA) Update. The first apparatus may signal to the network to change slice registration area (e.g. TA, RNA) such that the network may provide dedicated configuration to the first apparatus as needed. For example, the dedicated configuration is associated with the configuration provided to a UE via dedicated signaling as the UE transitions into RRC_CONNECTED state. See FIG. 4 and FIG. 5 and associated description in which slice area registration update may be based on mobility registration update or RAN Notification Area (RNA) Update. Further, UE signal to the network change of slice registration area (e.g. TA, RNA) such that the network may provide dedicated configuration to the UE as needed. The network slice configuration may have been received in system information broadcast signaling, a paging message, or a non-access-stratum signaling message. The first apparatus may initially be in RRC_IDLE or RRC_INACTIVE state. The network slice configuration may initially be received when the first apparatus was in a RRC_CONNECTED state, in which it then subsequently transitioned into RRC_IDLE state or RRC_INACTIVE state; and based on the received network slice configuration while in the subsequently transitioned RRC_IDLE state and RRC_INACTIVE state, performing, by the first apparatus, the following: cell selection; cell reselection; slice area registration update; radio resource control (RRC) connection establishment; RRC resume; public land mobile network (PLMN) selection; access control; random access; or paging reception. the first apparatus may be a user equipment. The second apparatus may be a base station or a core network node such as AMF. All combinations in this paragraph and above paragraphs (including the removal or addition of steps) are contemplated in a manner that is consistent with the other portions of the detailed description.

What is claimed:

1. A method comprising:
receiving, from a second apparatus, information including a network slice configuration, wherein the network slice configuration comprises network slice selection assistance information (NSSAI), single-NSSAI (S-NSSAI), slice/service type (SST), or slice differentiator (SD); and
based on the network slice configuration, performing, by a first apparatus:
cell selection;
cell reselection;
slice area registration update;
radio resource control (RRC) connection establishment;
RRC resume;
public land mobile network (PLMN) selection;
access control;
random access; or
paging reception.

2. The method of claim 1, wherein the NSSAI, the S-NSSAI, the SST, or the SD is configured into the first apparatus as available or not available per cell, per physical cell identifier, per TA, per radio access network notification area, or per frequency.

3. The method of claim 1, wherein the cell selection or cell reselections uses slice priority.

4. The method of claim 1, when performing slice area registration update is based on mobility registration update or radio access network (RAN) notification area (RNA) update.

5. The method of claim 1, wherein the network slice configuration was received in system information broadcast signaling.

6. The method of claim 1, wherein the network slice configuration was received in a paging message.

7. The method of claim 1, wherein the network slice configuration was received in a non-access-stratum signaling message.

8. The method of claim 1, wherein the first apparatus is in RRC_IDLE or RRC_INACTIVE state.

9. The method of claim 1, wherein the network slice configuration was received when the first apparatus was in a RRC_CONNECTED state, and further comprising:
subsequently transitioning into RRC_IDLE state or RRC_INACTIVE state; and
based on the received network slice configuration while in the subsequently transitioned RRC_IDLE state and RRC_INACTIVE state, performing, by the first apparatus:
cell selection;
cell reselection;
slice area registration update;
RRC connection establishment;
RRC resume;
PLMN selection;
access control;
random access; or
paging reception.

10. The method of claim 1, wherein the first apparatus is a user equipment.

11. A first apparatus comprising:
a processor; and
a memory coupled with the processor, the memory storing executable instructions that when executed by the processor cause the processor to effectuate operations comprising:
receiving, from a second apparatus, information including a network slice configuration, wherein the network slice configuration comprises network slice selection assistance information (NSSAI), single-NSSAI (S-NSSAI), slice/service type (SST), or slice differentiator (SD); and
based on the network slice configuration, performing:
cell selection;
cell reselection;
slice area registration update;
radio resource control (RRC) connection establishment;
RRC resume;
public land mobile network (PLMN) selection;
access control;
random access; or
paging reception.

12. The method of claim 1, wherein the NSSAI, the S-NSSAI, the SST, or the SD is configured into the first apparatus as available or not available per cell, per physical cell identifier, per TA, per radio access network notification area, or per frequency.

13. The method of claim 1, wherein the cell selection or cell reselections uses slice priority.

14. The method of claim 1, when performing slice area registration update is based on mobility registration update or radio access network (RAN) notification area (RNA) update.

15. The method of claim 1, wherein the network slice configuration was received in system information broadcast signaling.

16. The method of claim 1, wherein the network slice configuration was received in a paging message.

17. The method of claim 1, wherein the network slice configuration was received in a non-access-stratum signaling message.

18. The method of claim 1, wherein the first apparatus is in RRC_IDLE or RRC_INACTIVE state.

19. A method comprising:
sending, from a second apparatus, information including a network slice configuration, wherein the network slice configuration comprises network slice selection assistance information (NSSAI), single-NSSAI (S-NSSAI), slice/service type (SST), or slice differentiator (SD); and
in response to sending the information, receiving a message from a first apparatus associated with performing:
cell selection;
cell reselection;
slice area registration update;
radio resource control (RRC) connection establishment;
RRC resume;
public land mobile network (PLMN) selection;
access control;
random access; or
paging reception.

20. The method of claim 19, wherein the second apparatus is a base station.
